(19) United States
(12) Patent Application Publication
(10) Pub. No.: US 2025/0231314 A1
(43) Pub. Date: Jul. 17, 2025

(54) METHODS AND SYSTEMS FOR MULTI-WELL SIMULTANEOUS WELL LOGGING

(71) Applicant: SAUDI ARABIAN OIL COMPANY, DHAHRAN (SA)

(72) Inventors: Klemens Katterbauer, Dhahran (SA); Abdallah A. AlShehri, Dhahran (SA); Abdulaziz Al Qasim, Dammam (SA); Ali Abdullah Al Yousif, Dhahran (SA)

(73) Assignee: SAUDI ARABIAN OIL COMPANY, Dhahran (SA)

(21) Appl. No.: 18/412,179

(22) Filed: Jan. 12, 2024

(51) Int. Cl. G01V 3/20; E21B 41/00; E21B 49/00; H04W 24/02

(52) U.S. Cl. CPC G01V 3/20; E21B 41/00; E21B 49/00; H04W 24/02

(57) ABSTRACT

A method for optimizing satellite performance in a multi-well simultaneous logging system, the method including obtaining transceiver data from at least one satellite and from a plurality of base stations, where each base station includes a surface antenna and is associated with an oil and gas well. The method further includes obtaining a set of transceiver parameters related to the at least one satellite and the plurality of surface antennas. The method further includes determining, with a dual artificial intelligence (AI) model including a first artificial intelligence model, a predicted satellite performance based on the transceiver data and the set of transceiver parameters. The method further includes determining, with an optimizer applied to the dual AI model, an optimal set of transceiver parameters such that the predicted satellite performance is optimized and adjusting, automatically, the set of transceiver parameters to the optimal set of transceiver parameters.

### BACKGROUND

Properties of a subsurface formation may be determined using various measurements obtained through logging tools. For example, these measurements may be used to calculate porosity, permeability, and other properties of a reservoir formation. However, in many situations, logging tool measurements may prove inaccurate due to interference and unique conditions within a wellbore. This problem is further exacerbated when attempting to monitor and/or perform well logging across multiple different wells simultaneously.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method for optimizing satellite performance in a multi-well simultaneous logging system, the method including obtaining transceiver data from at least one satellite and from a plurality of base stations, where each base station of the plurality of base stations is associated with an oil and gas well. Each base station of the plurality of base stations includes at least one surface antenna. The method further includes obtaining a set of transceiver parameters related to the at least one satellite and the plurality of surface antennas. The method further includes determining, with a dual artificial intelligence (AI) model including a first artificial intelligence model, a predicted satellite performance based on the transceiver data and the set of transceiver parameters. The method further includes determining, with an optimizer applied to the dual AI model, an optimal set of transceiver parameters such that the predicted satellite performance is optimized and adjusting, automatically, the set of transceiver parameters to the optimal set of transceiver parameters.

Embodiments disclosed herein generally relate to a system including a plurality of base stations and a satellite in communication with the plurality of base stations. The satellite includes a satellite control system configured to adjust satellite parameters related to the satellite. Each base station of the plurality of base stations is associated with an oil and gas well, and each base station of the plurality of base stations includes at least one surface antenna. The operation of the satellite and the plurality of surface antennas included by the plurality of base stations is defined by a set of transceiver parameters. The system further includes a plurality of transceiver devices disposed throughout the plurality of base stations, the plurality of transceiver devices gathering transceiver data from the satellite and the plurality of surface antennas. The system further includes a control system configured to adjust one or more transceiver devices in the plurality of base stations and a computer. The computer is configured to obtain the transceiver data for the satellite and the plurality of surface antennas, obtain the set of transceiver parameters for the satellite and the plurality of surface antennas, and determine, with a dual AI model including a first AI model, a predicted satellite performance based on the transceiver data and the set of transceiver parameters. The computer is further configured to determine, with an optimizer applied to the dual AI model, an optimal set of transceiver parameters such that the predicted satellite performance is optimized, and adjust, automatically, the set of transceiver parameters to the optimal set of transceiver parameters to optimize the predicted satellite performance.

Embodiments disclosed herein generally related to a non-transitory computer-readable memory comprising computer-executable instructions stored thereon that, when executed on a processor, cause the processor to perform the following steps. The steps include obtaining transceiver data for at least one satellite and a plurality of surface antennas. Each surface antenna of the plurality of surfaces antennas is included by one of a plurality of base stations associated with oil and gas wells. The steps further include determining, with a dual artificial intelligence (AI) model including a first artificial intelligence model, a predicted satellite performance based on the transceiver data, in view of a set of transceiver parameters that control the operation of the at least one satellite and plurality of surface antennas. The steps further include determining, with an optimizer applied to the dual AI model, an optimal set of transceiver parameters such that the predicted satellite performance is optimized, and adjusting, automatically, the set of transceiver parameters to the optimal set of transceiver parameters.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 depicts a multi-well simultaneous logging system in accordance with one or more embodiments.

FIG. 2 depicts a system in accordance with one or more embodiments.

FIG. 3 depicts a system in accordance with one or more embodiments.

FIG. 4 depicts a system in accordance with one or more embodiments.

FIG. 5A depicts a system in accordance with one or more embodiments.

FIG. 5B depicts a system in accordance with one or more embodiments.

FIG. 6 depicts a flowchart in accordance with one or more embodiments.

FIG. 7 depicts a flowchart in accordance with one or more embodiments.

FIG. 8 depicts a neural network in accordance with one or more embodiments.

FIG. 9A depicts a recurrent neural network in accordance with one or more embodiments.

FIG. 9B depicts an unrolled recurrent neural network in accordance with one or more embodiments.

FIG. 9C depicts a long short-term memory network in accordance with one or more embodiments.

FIG. 10 depicts a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, an “oil or gas well,” may include any number of “oil or gas wells” without limitation.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

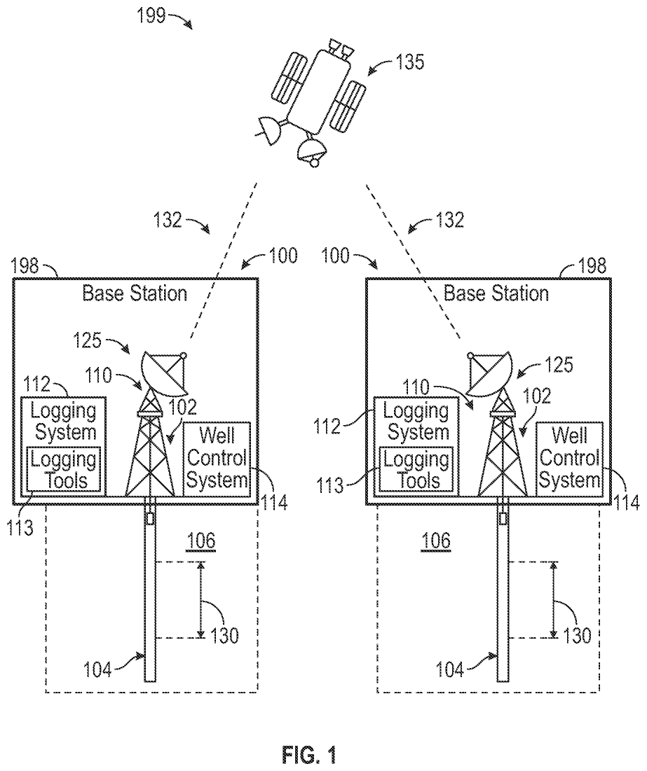

In the following description of FIGS. 1-10, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

In general, embodiments of the disclosure include systems and methods for simultaneous well logging across multiple oil and gas wells. The oil and gas wells may be associated with geological underground (i.e., “subsurface”) formations from which oil and gas may be extracted. The oil and gas wells considered may alternatively be associated with any type of storage horizon, where “storage horizon” is defined as a subsurface formation, group of formations, or part of a formation that receives, and/or stores injected fluids. In one or more embodiments, a storage horizon may be a depleted natural gas or oil field, aquifer, or salt formation. Both the injected and extracted fluids may be multiphase and be composed of a variety of solid, liquid, and gaseous constituents. The oil and gas wells may be substantially distant from one another, without limitation to their separation. As such, the wells may include combinations of both offshore and onshore wells.

Well logging generally refers to measuring various physical properties of a subsurface formation, group of formations, or part of a formation as a function of depth within a drilled hole. Hereafter, “formation” may refer to a single formation, group of formations, or part of a formation. One immediate result of well logging includes well “logs” that contain the measurements as a function of depth. Well logs may be used to evaluate the properties of formation to further determine subsequent operations such as a geosteering procedure for drilling, and they may be used to inform well placement and reservoir contact zone penetration, among other uses not listed.

In accordance with one or more embodiments, systems of the instant disclosure include at least one satellite and a plurality of base stations, where each base station of the plurality of base stations is associated with an oil and gas well. In one or more embodiments, several satellites may be employed in concert, and descriptions in the instant disclosure of the at least one satellite may equally apply to the other included satellites. The oil and gas wells may themselves be associated with any type of subsurface formation, including those used for fluid extraction and storage. Examples of subsurface formations used for fluid extraction may include conventional and unconventional hydrocarbon reservoirs. Examples of subsurface formations used for fluid storage may include storage horizons configured for storing carbon dioxide, hydrogen, methane, and other fluids not listed. Each well considered may be actively obtaining logging measurements, or they may have obtained logging measurements which also include a record of time associated with the measurements. The oil and gas wells are located in proximity to the base stations subject to physical and environmental constraints that allow communication, either wired or remote, of the acquired well logs to the base station. Each base station also includes at least one surface antenna used to communicate with the satellite. The surface antenna includes both a transmitter, to send data to the satellite, and a receiver, to receive data from the satellite. Using the surface antennas, each base station communicates the respective well logs to the satellite, enabling real-time monitoring of the well logging operations across the plurality of wells. The operation of both the satellite and the surface antennas is controlled through assignation of a set of transceiver parameters to a given state or value. The overall satellite performance may be quantified by a time-averaged data transfer rate between the satellite and surface antennas, and average aerial coverage of the base stations achieved by the satellite, among other metrics not listed. The satellite performance is therefore sensitive to physical and environmental constraints that impact communication with the surface antennas, as well as the set of transceiver parameters that define the operation of both the satellite and surface antennas. In one or more embodiments, the set of transceiver parameters are adjusted, automatically and in real time, to optimize the satellite performance.

In one or more embodiments, the satellite performance is predicted using a dual artificial intelligence (AI) model, including at least one AI model, based on (or accepts as inputs), at least, the transceiver parameters. In one or more embodiments, the AI model may further make use of transceiver data obtained by both the surface antennas and the satellite. The transceiver data may include the location of the satellite, the altitude of the satellite, the direction one or more surface antenna is pointing (i.e., the orientation), in addition to other information related to the communication between the surface antennas and satellite. Using the dual AI model to predict satellite performance, an optimal set of transceiver parameters may be determined by applying an optimizer to the dual AI model.

Many challenges may be experienced during logging-while-drilling (LWD) or measurement-while-drilling (MWD) according to several factors. As one example, limited information regarding heterogeneity among different rock formations may introduce variation in logging measurements. Accordingly, some embodiments use dual or multiple logging techniques for acquiring measurements substantially simultaneously or time-lagged among different drilled wells. For illustration, by accounting for similar interference in sensing signals among different logging tools at different wells, artificial intelligence methods may combine the signals to improve logging measurements. Combining and analyzing logging measurements obtained from as few as two different wells may be sufficient to improve the individual sets of logging measurements. Further improvement to well logging measurements may be achieved by combining logging measurements from different wells in numbers larger than two. Whether only two wells are considered, or many more wells without limitation are considered, the difficulty and challenge of actively monitoring well logging operations in real-time increases with the physical separation of the different wells.

Additionally, for some applications, it may be preferable to obtain the measurements from the different wells with rapid cadence, such as when the well logging is happening in real-time (e.g., LWD and MWD). In accordance with one or more embodiments, systems of the instant disclosure overcome both of these challenges by monitoring the operations of different wells, including logging operations, through communication with at least one satellite. In one or more embodiments, operations at the well, including logging, extraction, injection, drilling, and other activities are controlled through assignation of a set of well operation parameters to a given state or value. The quality of the logging measurements are affected by the set of well operation parameters. In one or more embodiments, the set of well operation parameters are adjusted, automatically and in real time, to optimize the well logging.

In one or more embodiments, the well logging is predicted using the dual artificial intelligence (AI) model based on at least, the well operation parameters. In one or more embodiments, the AI model may further make use of well operation data obtained at the plurality of wells. The well operation data may include the well logs themselves and subsets thereof, including only a portion of the spanned depth or a portion of the interval of time across which they were recorded. The well operation data may also include the net rate of fluid into and out of the well, the total amount of fluid present at a given moment in time, the temperature, volume, and pressure inside of the well, and the temperature, volume and pressure inside of the subsurface formation, among other qualities not listed. Using the dual AI model to predict well logging, an optimal set of well operation parameters may be determined by applying an optimizer to the dual AI model.

FIG. 1 shows a schematic diagram in accordance with one or more embodiments. More specifically, FIG. 1 illustrates a multi-well simultaneous logging system (199) including a satellite (135). Though only one satellite (135) is depicted, one or more embodiments include additional satellites without limitation. The satellites communicate with a two-way communication signal (132) through which data is both transmitted and received. The satellites communicate with base stations (198) equipped with surface antennas (125). The base stations are associated with and are located in proximity to oil and gas wells (102), subject to physical and environmental constraints. For example, one base station (198) may be located directly adjacent to a well (102) of a given type if there are no physical impediments, while another base station (198) may be located some distance apart from the well (102) to avoid interaction between the surface antenna (125) and components of the well (102). In some embodiments, the base stations (198) may not be physical structures themselves but rather represent a collection of mechanical components located in proximity to a well, minimally including a surface antenna (125). The physical area in which the base stations and wells reside may be referred to as the well environment (100). Well environments (100) may be offshore or onshore. Each well may include a wellbore (104) extending into a formation (106). The wellbore (104) may include a bored hole that extends from the surface into a target zone of the formation (106), such as a reservoir. The formation (106) may include various formation characteristics of interest, such as formation porosity, formation permeability, resistivity, density, water saturation, and the like. Porosity may indicate how much space exists in a particular rock within an area of interest in the formation (106), where oil, gas, and/or water may be trapped. Permeability may indicate the ability of liquids and gases to flow through the rock within the area of interest. Resistivity may indicate how strongly rock and/or fluid within the formation (106) opposes the flow of electrical current. For example, resistivity may be indicative of the porosity of the formation (106) and the presence of hydrocarbons. More specifically, resistivity may be relatively low for a formation that has high porosity and a large amount of water, and resistivity may be relatively high for a formation that has low porosity or includes a large amount of hydrocarbons. Water saturation may indicate the fraction of water in a given pore space.

Continuing with FIG. 1, the well environment (100) may include a well (102), a drilling system (110), a logging system (112), and a well control system (114). The drilling system (110) may include a drill string, drill bit, a mud circulation system and/or the like for use in boring the wellbore (104) into the formation (106). The well control system (114) may include hardware and/or software for managing drilling operations, injection/extraction operations, and/or maintenance operations. For example, the well control system (114) may include one or more programmable logic controllers (PLCs) that include hardware and/or software with functionality to control one or more processes performed by the drilling system (110). Specifically, a programmable logic controller may control valve states, fluid levels, pipe pressures, warning alarms, and/or pressure releases throughout a drilling rig, storage horizon, or well. In particular, a programmable logic controller may be a ruggedized computer system with functionality to withstand vibrations, extreme temperatures, wet conditions, and/or dusty conditions, for example, around a drilling rig, storage horizon, or well. Without loss of generality, the term “well control system” may refer to an operation control system that is used to operate and control equipment for drilling, injection, and extraction, a data acquisition and monitoring system that is used to acquire process and equipment data and to monitor the operation of the drilling, injection, and extraction processes, or an interpretation software system that is used to analyze and understand drilling, injection, and extraction events and progress. A logging system may be similar to a well control system with a specific focus on managing one or more logging tools.

The logging system (112) may include one or more logging tools (113), such as a nuclear magnetic resonance (NMR) logging tool and/or a resistivity logging tool, for use in generating well logs of the formation (106). For example, a logging tool may be lowered into the wellbore (104) to acquire measurements as the tool traverses a depth interval (130) (e.g., a targeted reservoir section) of the wellbore (104). The plot of the logging measurements versus depth may be referred to as a “log” or “well log”. Well logs may provide depth measurements of the well (102) that describe such reservoir characteristics as formation porosity, formation permeability, resistivity, density, water saturation, and the like. The resulting logging measurements may be stored and/or processed, for example, by the well control system (114), to generate corresponding well logs for the well (102). A well log may include, for example, a plot of a logging response time versus true vertical depth (TVD) across the depth interval (130) of the wellbore (104).

Reservoir characteristics may be determined using a variety of different techniques. For example, certain reservoir characteristics can be determined via coring (e.g., physical extraction of rock samples) to produce core samples and/or logging operations (e.g., wireline logging, logging-while-drilling (LWD) and measurement-while-drilling (MWD)). Coring operations may include physically extracting a rock sample from a region of interest within the wellbore (104) for detailed laboratory analysis. For example, when drilling an oil or gas well, a coring bit may cut plugs (or “cores” or “core samples”) from the formation (106) and bring the plugs to the surface, and these core samples may be analyzed at the surface (e.g., in a lab) to determine various characteristics of the formation (106) at the location where the sample was obtained.

To determine porosity in the formation (106), various types of logging techniques may be used. For example, the logging system (112) may measure the speed that acoustic waves travel through rocks in the formation (106). This type of logging may generate borehole compensated (BHC) logs, which are also called sonic logs or acoustic logs. In general, acoustic waves may travel faster through high-density shales than through lower-density sandstones. Likewise, density logging may also determine density measurements or porosity measurements by directly measuring the density of the rocks in the formation (106). Furthermore, neutron logging may determine porosity measurements by assuming that the reservoir pore spaces within the formation (106) are filled with either water or oil and then measuring the amount of hydrogen atoms (i.e., neutrons) in the pores. In some embodiments, gamma ray logging is used to measure naturally occurring gamma radiation to characterize rock or sediment regions within a wellbore. In particular, different types of rock may emit different amounts and different spectra of natural gamma radiation. For example, gamma ray logs may distinguish between shales and sandstones/carbonate rocks because radioactive potassium may be common to shales. Likewise, the cation exchange capacity of clay within shales also results in higher absorption of uranium and thorium further increasing the amount of gamma radiation produced by shales.

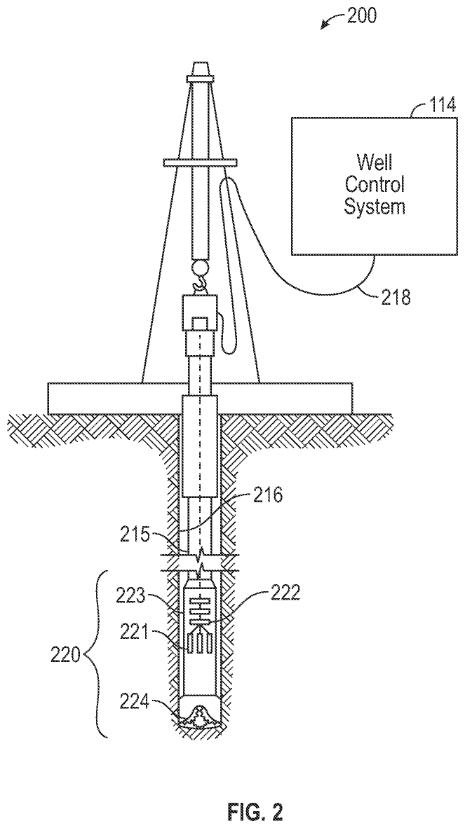

FIG. 2 illustrates a well control system (114) in accordance with one or more embodiments. In this particular instance, well control system (114) need not be identical to the one depicted in FIG. 1, and for concision, new numeric labels are not used for previously described, like elements. In the embodiment illustrated by FIG. 2, the well control system (114) is shown with a connection (218) to a drilling system (200), controlling its operation. Sensors (221) may be included in a sensor assembly (223), which is positioned adjacent to a drill bit (224) and coupled to the drill string (215). Sensors (221) may also be coupled to a processor assembly (223) that includes a processor, memory, and an analog-to-digital converter (222) for processing sensor measurements. For example, the sensors (221) may include acoustic sensors, such as accelerometers, measurement microphones, contact microphones, and hydrophones. Likewise, the sensors (221) may include other types of sensors, such as transmitters and receivers to measure resistivity, gamma ray detectors, etc. The sensors (221) may include hardware and/or software for generating different types of well logs (such as acoustic logs or density logs) that may provide well log data about a wellbore, including porosity of wellbore sections, gas saturation, bed boundaries in a geologic formation, fractures in the wellbore or completion cement, and many other pieces of information about a formation. If such well log data is acquired during drilling operations (e.g., LWD or mwd), then the information may be used to make adjustments to drilling parameters in real-time. Such adjustments may include rate of penetration (ROP), a bottom-hole circulating pressure, one or more drilling directions, altering mud weight, the amount of weight-on-bit, and many others drilling parameters.

In some embodiments, acoustic sensors may be installed in a drilling fluid circulation system of a drilling system (200) to record acoustic drilling signals in real-time. Drilling acoustic signals may transmit through the drilling fluid to be recorded by the acoustic sensors located in the drilling fluid circulation system. The recorded drilling acoustic signals may be processed and analyzed to determine well data, such as lithological and petrophysical properties of the rock formation. This well data may be used in various applications, such as steering a drill bit using geosteering, casing shoe positioning, etc.

The well control system (114) may be coupled to the sensor assembly (223) with the connection (218) in order to perform various program functions for up-down steering and left-right steering of the drill bit (224) through the wellbore (216). More specifically, the well control system (114) may include hardware and/or software with functionality for geosteering a drill bit through a formation in a lateral well using sensor signals, such as drilling acoustic signals or resistivity measurements. For example, the formation may be a reservoir region, such as a pay zone, bed rock, or cap rock. Geosteering may be used to position the drill bit (224) or drill string (215) relative to a boundary between different subsurface layers (e.g., overlying, underlying, and lateral layers of a pay zone) during drilling operations. In particular, measuring rock properties during drilling may provide the drilling system (200) with the ability to steer the drill bit (224) in the direction of desired hydrocarbon concentrations. As such, a geosteering system may use various sensors located inside or adjacent to the drill string (215) to determine different rock formations within a wellbore's path. In some geosteering systems, drilling tools may use resistivity or acoustic measurements to guide the drill bit (224) during horizontal or lateral drilling.

Returning to FIG. 1, in one or more embodiments, geosteering may be used to position the drill bit or drill string of the drilling system (110) relative to a boundary between different subsurface layers (e.g., overlying, underlying, and lateral layers of a pay zone) during drilling operations. In particular, measuring rock properties during drilling may provide the drilling system (110) with the ability to steer the drill bit in the direction of desired hydrocarbon concentrations. As such, a geosteering system may use various sensors located inside or adjacent to the drill string to determine different rock formations within a well path. In some geosteering systems, drilling tools may use resistivity or acoustic measurements to guide the drill bit during horizontal or lateral drilling.

While some of the methods described above are particularly relevant for LWD and MWD, a person of ordinary skill in the art would understand that obtaining the measurements described above are not limited to embodiments of LWD; these measurements may be obtained and gathered as well logs using similar tools not involving a drilling system and after drilling has been completed.

The base stations (198) communicate with the satellite (135) using the surface antennas (125). The communications involve a two-way communication signal (132) through which information is both transmitted and received. Generally, complex interactions between the satellite (135) and surface antennas (125) exist such that configuring the satellite (135) and surface antennas (125) is a difficult and laborious task. Further, the state and behavior of the satellite performance and two-way communication signal (132) may be transient according to the physical locations of the surface antennas and their displacement with respect to each other, as well as the transient conditions encountered by the satellite during its orbit (e.g., the satellite may experience different orientations with respect to one or more surface antennas, or it may experience more or less sunlight which may affect its operation).

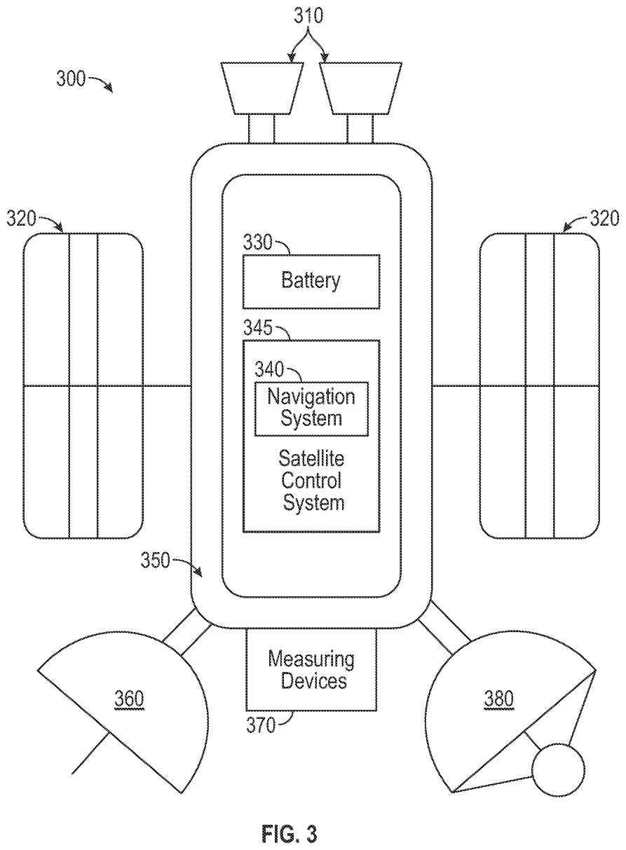

FIG. 3 depicts a schematic diagram representing one possible embodiment of a satellite (e.g., Satellite Z (300)). Although only one satellite is shown, in some embodiments, many satellites sharing similar properties may be used. It is emphasized that FIG. 3 is only schematic and illustrative. FIG. 3 is not meant to impart actual physical or relative scale. In some embodiments, a satellite may be described as a self-contained orbiting communications system with the ability to receive signals from Earth and to transmit signals back to Earth. Two-way communication such as this may be achieved using a transmitter (360) and a receiver (380). In some embodiments, the satellite may use a transceiver which is a single device integrating a receiver and transmitter of radio signals. In other embodiments, the satellite may use a transponder, which is a single device integrating a responder and a transmitter of radio signals such that, upon receiving one signal, another signal is automatically transmitted back (i.e., a response).

The satellite is capable to withstand the shock of being accelerated during launch up to the orbital velocity of 28,100 km (17,500 miles) per hour as well as a hostile space environment where it may be subject to radiation and extreme temperatures for its projected operational life. In one or more embodiments, the satellite structure is surrounded with shielding (350) capable of protecting the satellite from the shock of acceleration at launch, harmful radiation in space, reentry through the Earth's atmosphere (i.e., atmospheric friction), and impact with water upon landing at the end of its operation such that it may be found intact and recycled. The shielding is lightweight to limit costs associated with launch which depend on payload weight. Material used in the satellite typically includes the same coefficient of thermal expansion as the system used to deploy the satellite to prevent jamming; a person of ordinary skill in the art would know commonly used coefficients of expansion. The satellite operates at a very high reliability of more than 99.9 percent in the vacuum of space with no need of maintenance or repair. A common construction material meeting all of the requirements for the satellite is aluminum, though in some cases titanium may be preferrable. Aluminum is lightweight (i.e., at fixed size, aluminum is roughly half as heavy as titanium), durable, resistant to corrosion, thermally and electrically conductive.

In one or more embodiments, the satellite (e.g., Satellite Z (300)) includes a propulsion system (310), which may include rockets that propel the satellite. The satellite requires its own propulsion system (310) to maneuver itself to the appropriate orbital location and to make occasional corrections to that position. For example, a given satellite in geostationary orbit can deviate up to a degree every year from north to south or east to west of its location because of the gravitational pull of the Moon and Sun. The satellite uses the propulsion system (310) to make adjustments to position, orientation, and trajectory. The propulsion system (310) may include chemical thrusters, resistojet rockets, or an electric propulsion system, among others not listed.

In one or more embodiments, the satellite (e.g., Satellite Z (300)) uses a navigation system (340) to monitor and control its position. The navigation system may further monitor the position of the satellite with respect to the Earth, one or more surface antennas, and other satellites; this operation is commonly referred to as orbital station keeping. Regarding adjusting satellite orientation (i.e., attitude control), an inertial reference frame, such as the celestial sphere, may be used. Using the inertial reference frame, the satellite may measure its displacement through the three planes of motion. Attitude control is also mediated by the navigation system. In some embodiments, the navigation system may use a momentum wheel to adjust the satellite attitude. In other embodiments, the satellite may use spin-control procedures for attitude control. The navigation system (340) may send signals to the propulsion system (310) for both orbital station keeping, attitude control, and other flight adjustments. Using the navigation system (340), the satellite may also monitor its own location throughout its orbit and during the time that the satellite eventually reenters the Earth's atmosphere and lands in water, such that it may be retrieved and recycled. The location of the satellite may be monitored through communication with any of the global navigation satellite systems (GNSS), such as GPS (Global Positioning System), GLONASS, GALILEO, or BeiDou.

In one or more embodiments, the satellite (e.g., Satellite Z (300)) is powered by energy harnessed from the sun using solar panels (320). Solar panels are common on satellites and contain photovoltaic cells made of semiconducting material (commonly silicon) that emit electrons when irradiated with photons thus generating an electric current. In addition to obtaining energy for the operation of the satellite directly, the solar panels (320) generate electricity that, in one or more embodiments, may be stored in a battery (330). Sufficiently charging the battery may enable the satellite to operate in orbital configurations that deviate from optimal irradiation by the sun.

In one or more embodiments, the satellite (e.g., Satellite Z (300)) also includes a number of measuring devices (370). The measuring devices (370) may include imaging systems, radiometers, and spectrometers. The measuring devices (370) may gather temporal data, radiometric data, spatial data, and spectral data, each spanning radio through optical wavelengths. In some embodiments, the measurements acquired by the measuring devices (370) may relate to a well environment (e.g., the well environment (100) of FIG. 1). For the purpose of illustration, considering with the well environment (100) of FIG. 1, the measurements obtained by the measuring devices (370) may include graphical images of the operations at the well and images of surface displacement from drilling. The measurements from the measuring devices (370) may also include spectroscopy, radiometry, or imaging indicating gas (i.e., carbon dioxide, methane, hydrogen, etc.) emission and/or content at the well, and data pertaining to temperature. Generally speaking, the measurements obtained by the measuring devices (370) may enable tracking of well operations from orbit.

In one or more embodiments, the overall operation of the satellite (e.g., Satellite Z (300)) is governed by the satellite control system (345). The satellite control system (345) may be connected to the navigation system (340) and the propulsion system (310), issuing commands to fire thrusters for both orbital station keeping and attitude control. The satellite control system (345) may alternatively (or additionally) be connected to the solar panels and battery, and issue commands to send electricity through the battery under certain conditions, for example, during maximum irradiation from the sun. The satellite control system (345) may alternatively (or additionally) be connected to the transmitter (360), receiver (380), and measuring devices (370), managing both data acquisition through both the receiver (380) and measuring devices (370) as well as data transmission using the transmitter (360). Generally, complex interactions between the satellite components listed above exist such that configuring the satellite for efficient operation at extended duration is a difficult and laborious task. Further, the state and behavior of the satellite may be transient according to the transient conditions encountered by the satellite during its orbit (e.g., the satellite may experience more or less amounts of harmful cosmic radiation, solar radiation, and attitude adjustments).

Regarding the components of the multi-well simultaneous logging system, the various systems and facilities may have associated with them both data, that describe the status of the given system or facility, and parameters, that define and control one or more aspects of their operation. For example, the satellite may have associated “satellite data” that describes both the external data acquired from the satellite, such as measurements of the surface of the Earth, and internal data related to its own functioning (e.g., the satellites current or past orientation and position), as well as “satellite parameters” that define the operation of the satellite. Likewise, the base stations including the surface antennas may have associated “link data” that describes the quality of the communication between the surface antennas and the satellite, as well as “antenna parameters” that define the operation of the antennas. Similarly, each well may have two different sets of data, both from the well control system in the form of “well production data” describing processes either completed or ongoing within the well, and from the logging system in the form of “well logs” describing completed or ongoing measurements of the physical properties within the well. Further considering the wells, each well may have two different sets of parameters, both from the well control system in the form of “well production parameters” that define the operation of the well with respect to drilling, injection, and extraction, and from the logging system in the form of “logging parameters” that define the operation of the logging system.

In one aspect, embodiments disclosed herein relate to a system for determining the set of transceiver parameters, including the satellite parameters and antenna parameters, that optimize the satellite performance in a multi-well simultaneous logging system. Embodiments disclosed herein also relate to a system for determining the set of well operation parameters, including the well production parameters and logging parameters, that optimize the well logging across a plurality of different well in a multi-well simultaneous logging system. The optimal set of transceiver parameters and the optimal set of well operation parameters are determined with a dual artificial intelligence (AI) model, including at least one AI model, taking into consideration the current state of the satellite via the satellite data, the current state of the surface antennas via the link data, the current state of the well control system via the well production parameters, and the current state of the logging system via the logging parameters. In accordance with one or more embodiments, the satellite parameters, the antenna parameters, the well production parameters, and the logging parameters may be adjusted automatically, and in real-time, through control systems disposed throughout the various elements (e.g., the satellite is controlled by a satellite control system) capable of receiving commands, the commands based on the dual AI model under optimization.

In accordance with one or more embodiments, transceiver data (including, in some embodiments, satellite data from a satellite and link data from surface antennas) are processed with a composite artificial intelligence (AI) model to predict a satellite performance from a satellite involved in a multi-well simultaneous logging system. A satellite performance may be quantified by time-averaged data throughput between the satellite and surface antennas, average aerial coverage of the base stations achieved by the satellite, or average communication latency between the satellite and surface antennas, among other metrics not listed. A person of ordinary skill in the art would understand that instead of considering the average of the listed metrics as the governing summary statistic for quantifying satellite performance, many other summary statistics may be considered, such as the median or the mode, without limitation. A person of ordinary skill in the art would further understand that the satellite performance may be quantified by calculating moments of the distribution of one or more listed values (e.g., data throughput), such as the first moment being the expectation value of data throughput, the second moment being the variance of data throughput, the third moment being the skewness of the data throughput, and the fourth moment being the kurtosis of the data throughput. In one or more embodiments, it may be advantageous to achieve the minimum variance in data throughput, as an illustration. When multiple satellites are used, the satellite performance may be considered across all satellites or restricted to one or more satellites. The predicted satellite performance is used to determine an optimal set of transceiver parameters (including, in some embodiments, both the satellite parameters and the antenna parameters) for satellite performance considered in a multi-well simultaneous logging system.

In accordance with one or more embodiments, well operation data (including, in some embodiments, well production data from a well control system and well logs from a logging system) are processed with a composite artificial intelligence (AI) model to predict a well logging from a plurality of wells involved in a multi-well simultaneous logging system. The predicted well logging may be obtained by combining the signals from the different well logging systems in the plurality of wells such that variation and uncertainty in measurements are minimized. In turn, the predicted well logging is used to determine an optimal set of well operation parameters (including, in some embodiments, both the well production parameters and the logging parameters) for well logging considered in a multi-well simultaneous logging system.

Artificial intelligence, broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term artificial intelligence (AI), will be adopted herein, however, one skilled in the art will recognize that the concepts and methods detailed hereafter are not limited by this choice of nomenclature.

Artificial intelligence (AI) model types may include, but are not limited to, neural networks, random forests, generalized linear models, and Bayesian regression. AI model types are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. The selection of hyperparameters surrounding a model is referred to as selecting the model “architecture.” Generally, multiple model types and associated hyperparameters are tested and the model type and hyperparameters that yield the greatest predictive performance on a hold-out set of data is selected.

As noted, the objective of the dual AI model, composed of at least one AI model, is to determine the satellite performance from a multi-well simultaneous logging system in view of satellite data from an associated satellite (e.g., the current location of the satellite with respect to a fixed point on Earth) that affects the communication ability of a satellite and link data from a surface antenna. In some embodiments, the dual AI model is further informed by the set of transceiver parameters. Further, in one or more embodiments, the dual AI model also determines the well logging from a from a multi-well simultaneous logging system in view of well production data from a plurality of wells and their well control systems (e.g., the current rate of fluid extraction or drilling) that may affect measurements of physical qualities of the well and well logs from a logging system. In some embodiments, the dual AI model is further informed by the set of well operation parameters.

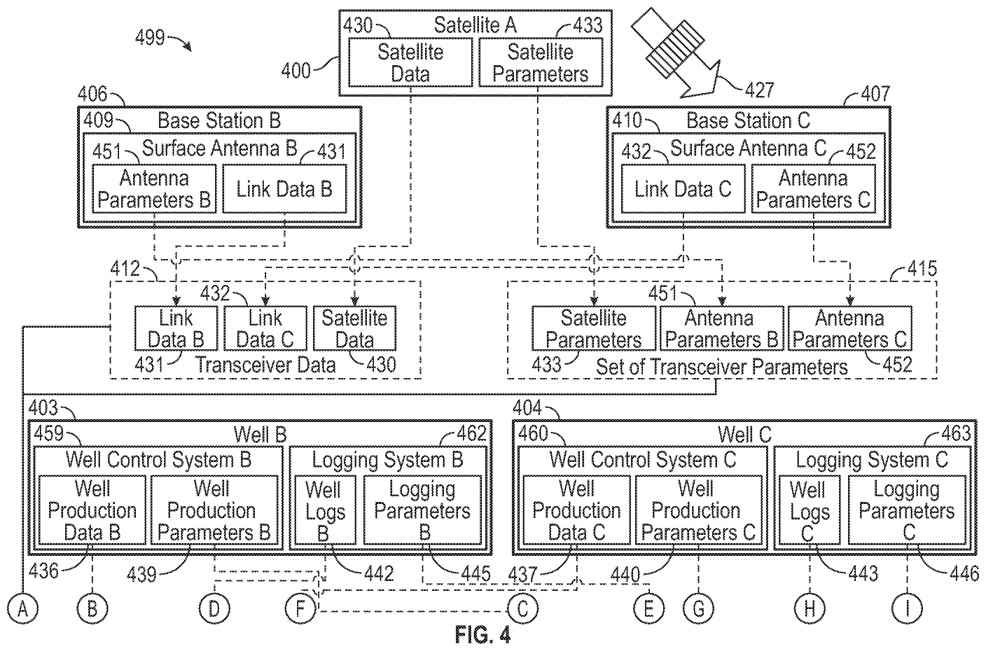

FIG. 4 depicts one embodiment of a multi-well simultaneous logging system (e.g., Multi-well simultaneous logging system W (499)). As such, the multi-well simultaneous logging system (e.g., Multi-well simultaneous logging system W (499)) includes at least one satellite (e.g., Satellite A (400)), a plurality of base stations (e.g., Base Station B (406) and Base Station C (407)), wherein each base station includes a surface antenna (e.g., Surface Antenna B (409) and Surface Antenna C (410)), a plurality of wells (e.g., Well B (403) and Well C (404)), wherein each well includes a well control system (e.g., Well Control System B (459) and Well Control System C (460)) and a logging system (e.g., Logging System B (462) and Logging System C (463)). The base stations are located in physical proximity to the wells, subject to environmental and physical constraints, and the wells may be either onshore or offshore. It is noted that embodiments of the instant disclosure are not limited to multi-well simultaneous logging systems and the associated facilities as depicted in FIG. 4. For example, while only one satellite may be used in one embodiment, in other embodiments, there may be a plurality of satellites working together, without limitation.

As seen in FIG. 4, the satellite (e.g., Satellite A (400)) has associated with itself satellite data (e.g., Satellite data (430)) and satellite parameters (e.g., Satellite parameters (433)); each surface antenna (e.g., Surface Antenna B (409) and Surface Antenna C (410)) has associated with itself link data (e.g., Link data B (431) and Link data C (432)) and antenna parameters (e.g., Antenna parameters B (451) and Antenna parameters C (452)); each well control system (e.g., Well Control System B (459) and Well Control System C (460)) has associated with itself well production data (e.g., Well production data B (436) and Well production data C (437)) and well production parameters (e.g., Well production parameters B (439) and Well production parameters C (440)); and each logging system (e.g., Logging System B (462) and Logging System C (463)) has associated with itself well logs (e.g., Well logs B (442) and Well logs C (443)) and logging parameters (e.g., Logging parameters B (445) and Logging parameters C (446)).

The status of the satellite (e.g., Satellite A (400)) is described, at least in part, by satellite data (e.g., Satellite data (430)). In one or more embodiments, the satellite data (e.g., Satellite data (430)) may include, for example, the total elapsed time of solar irradiance upon the solar panels (or the total amount of electricity produced), the current orientation of the satellite with respect to an inertial reference frame (or a history of its orientation), and measurements obtained by the satellite's measurement devices, such as spectroscopy, radiometry, or imaging indicating gas (i.e., carbon dioxide, methane, hydrogen, etc.) emission and/or content at one or more wells (e.g., Well B (403)). In one or more embodiments, the operation of the satellite (e.g., Satellite A (400)) is defined by satellite parameters (e.g., Satellite parameters (433)). The satellite parameters (e.g., Satellite parameters (433)) may include defining the orientation of the solar panels which affects the generation of electricity, defining the orientation of the satellite itself to affect its orbital station keeping, defining the satellite attitude and other feature of its orbit, and defining the time at which measurements are acquired or transmitted. When more than one satellite is included in the multi-well simultaneous logging system, the positions and orientations of the different satellites may also be defined by the satellite parameters (e.g., Satellite parameters (433)).

The satellite (e.g., Satellite A (400)) communicates with a plurality of base stations (e.g., Base Station B (406) and Base Station C (407)), where each base station includes a surface antenna (e.g., Surface Antenna B (409) and Surface Antenna C (410)). In one or more embodiments, the surface antennas (e.g., Surface Antenna B (409) and Surface Antenna C (410)) are each described, at least in part, by link data (e.g., Link data B (431) and Link data C (432)). In one or more embodiments, the link data (e.g., Link data B (431) and Link data C (432)) may include the current orientation (or the history of orientations) of one or more surface antennas (e.g., Surface Antenna B (409) and Surface Antenna C (410)) and the current data transfer rate (or a history of the data transfer rate) between one or more surface antennas (e.g., Surface Antenna B (409) and Surface Antenna C (410)) and the satellite (e.g., Satellite A (400)). In one or more embodiments, the operation of the surface antennas (e.g., Surface Antenna B (409) and Surface Antenna C (410)) is defined by antenna parameters (e.g., Antenna parameters B (451) and Antenna parameters C (452)). The antenna parameters (e.g., Antenna parameters B (451) and Antenna parameters C (452)) may include defining the orientation of the surface antennas (e.g., Antenna parameters B (451) and Antenna parameters C (452)), defining their physical separation or height, and defining the amount of data to send to the satellite (e.g., Satellite A (400)) at a given point in time. Note that the link data related to one particular surface antenna (e.g., Link data B (431) of Surface Antenna B (409)) need not be descriptive of the same features described by the link data related to a different surface antenna (e.g., Link data C (432) of Surface Antenna C (410)). Likewise, the antenna parameters defining the operation of one particular surface antenna (e.g., Antenna parameters B (451) of Surface Antenna B (409)) need not define the same operational mechanisms defined by the antenna parameters that define the operation of a different surface antenna (e.g., Antenna parameters C (452) of Surface Antenna C (410)).

The plurality of base stations (e.g., Base Station B (406) and Base Station C (407)) are each associated with an oil and gas well (e.g., Well B (403) and Well C (404)), where each well is associated with a subsurface formation and includes a well control system (e.g., Well Control System B (459) and Well Control System C (460)) and a logging system (e.g., Logging System B (462) and Logging System C (463)). The subsurface formation of each well may include those used for fluid extraction and storage. Examples of subsurface formations used for fluid extraction may include conventional and unconventional hydrocarbon reservoirs. Examples of subsurface formations used for fluid storage may include storage horizons configured for storing carbon dioxide, hydrogen, methane, and other fluids not listed. In one or more embodiments, each well control system (e.g., Well Control System B (459) and Well Control System C (460)) is described by well production data (e.g., Well production data B (436) and Well production data C (437)). The well production data (e.g., Well production data B (436) and Well production data C (437)) may describe the quantity of fluids of different types inside the well that may have been injected or may be extracted, and it may describe the volume, temperature, or pressure inside the well. In one or more embodiments, the operation of each well control system (e.g., Well Control System B (459) and Well Control System C (460)) is defined by well production parameters (e.g., Well production parameters B (439) and Well production parameters C (440)). The well production parameters (e.g., Well production parameters B (439) and Well production parameters C (440)) may include defining the rate at which fluids are injected or extracted from the well, in addition to the type of fluid to be injected or extracted, or defining a drilling procedure. Additionally, in one or more embodiments, each logging system (e.g., Logging System B (462) and Logging System C (463)) is described by well logs (e.g., Well logs B (442) and Well logs C (443)). The well logs (e.g., Well logs B (442) and Well logs C (443)) describe various physical properties about the well as a function of depth, such as its porosity, conductivity, and radioactivity, among others not listed. In one or more embodiments, the operation of each logging system (e.g., Logging System B (462) and Logging System C (463)) is defined by logging parameters (e.g., Logging parameters B (445) and Logging parameters C (446)). The logging parameters (e.g., Logging parameters B (445) and Logging parameters C (446)) may include defining an amplitude, a frequency, or a phase shift of an electrical sensing signal that is produced by a well logging resistivity tool, or they may include defining a rate at which another logging tool traverses a drilled well, such as a measuring device for radioactivity.

Note that the well production data and well logs related to one particular well control system and logging system (e.g., Well production data B (436) and well logs B (439) of Well Control System B (459) and Logging System B (462), respectively) need not be descriptive of the same features described by the well production data and well logs related to a different well control system and logging system (e.g., Well production data C (437) and well logs C (443) of Well Control System C (460) and Logging System C (463), respectively). Likewise, the well production parameters and logging parameters defining the operation of one particular well control system and logging system (e.g., Well production parameters B (439) and Logging parameters B (445) of Well Control System B (459) and Logging System B (462), respectively) need not define the same operational mechanisms defined by the well production parameters and logging parameters that define the operation of a different well control system and logging system (e.g., Well production parameters C (440) and Logging parameters C (446) of Well Control System C (460) and Logging System C (463), respectively).

As shown in FIG. 4, data related to communication (i.e., transmitting and receiving) and remote measurement are collectively stored as transceiver data (412). From the satellite (e.g., Satellite A (400)) this may include the satellite data (e.g., Satellite data (430)), and from the surface antennas (e.g., Surface Antenna B (409) and Surface Antenna C (410)) this may include the link data (e.g., Link data B (431) and Link data C (432)). The satellite data (e.g., Satellite data (430)) may include information regarding its position or orientation, and it may include measurements obtained of surface operations. The link data (e.g., Link data B (431) and Link data C (432)) may include information regarding the orientation of one or more surface antennas and current, past maximum and/or average data transfer rate between one or more surface antennas and the satellite. Similarly, the parameters that define the operation of elements related to communication and remote measurement are collectively stored as a set of transceiver parameters (415). From the satellite (e.g., Satellite A (400)) this may include the satellite parameters (e.g., Satellite parameters (433)), and from the surface antennas (e.g., Surface Antenna B (409) and Surface Antenna C (410)) this may include the antenna parameters (e.g., Antenna parameters B (451) and Antenna parameters C (452)). The satellite parameters (e.g., Satellite parameters (433)) may include defining which measuring device onboard the satellite to acquire a measurement from, defining the orientation of the satellite at a given moment in time, and defining the moments in time dictating when to switch from power obtained from its solar panels to power stored in its batteries. When multiple satellites are used in concert, the satellite parameters (e.g., Satellite parameters (433)) may include defining the positions of the satellites relative to each other. The antenna parameters (e.g., Antenna parameters B (451) and Antenna parameters C (452)) may include defining the moment in time dictating when to transmit data to the satellite, and defining the adjustable position, orientation, and height of one or more surface antennas. One with ordinary skill in the art will appreciate that additional transceiver data may be collected and that additional transceiver parameters may be considered without departing from the scope of this disclosure.

FIG. 4 additionally depicts that data related to the overall activities of the plurality of wells is gathered and stored as well operation data (413). From the well control systems (e.g., Well Control System B (459) and Well Control System C (460)) this may include well production data (e.g., Well production data B (436) and Well production data C (437)), and from the logging systems (e.g., Logging System B (462) and Logging System C (463)) this may include well logs (e.g., Well logs B (442) and Well logs C (443)). The well production data (e.g., Well production data B (436) and Well production data C (437)) may describe the current amount of fluids of various types within the well, or the temperature, volume, and pressure of the well. The well logs (e.g., Well logs B (442) and Well logs C (443)) may include multiple measures of the physical properties of the well as a function of depth, such as porosity, resistivity, radioactivity, diameter, density, among others. Similarly, the parameters that define the operation of the plurality of wells and their associated system are stored as a set of well operation parameters (416). From the well control systems (e.g., Well Control System B (459) and Well Control System C (460)) this may include well production parameters (e.g., Well production parameters B (439) and Well production parameters C (440)) and from the logging systems (e.g., Logging System B (462) and Logging System C (463)) this may include logging parameters (e.g., Logging parameters B (445) and Logging parameters C (446)). The well production parameters (Well production parameters B (439) and Well production parameters C (440)) may define the rate at which fluids are injected and extracted from the well or the rate of a drilling procedure. The logging parameters (e.g., Logging parameters B (445) and Logging parameters C (446)) may define the moments in time that various logging tools are employed as well as the associated duration, and the rate at which the logging tools traverse a depth interval. The logging parameters (e.g., Logging parameters B (445) and Logging parameters C (446)) may, for example, define an amplitude, a frequency, or a phase shift of an electrical sensing signal that is produced by a well logging resistivity tool. One with ordinary skill in the art will appreciate that additional well operation data may be collected and that additional well operation parameters may be considered without departing from the scope of this disclosure.

As has already been established, one or more satellites (e.g., Satellite A (400)) communicates with base stations (e.g., Base Station B (406) and Base Station C (407)) via surface antennas (e.g., Surface Antenna B (409) and Surface Antenna C (410)) associated with each base station. In one or more embodiments, a further significant feature is the communication between the plurality of wells (e.g., Well B (403) and Well C (404)) and the plurality of base stations (e.g., Base Station B (406) and Base Station C (407)). Herein, each well is capable of communication with a particular base station via physical communication cables, such as fiber optic cables, or though remote communication systems, such as communication over a wireless network. One possible pathway of information is presented for illustration as follows. A well (e.g., Well B (403)) transmits data (e.g., Well production data B (436) and Well logs B (442)) to its base station (e.g., Base Station B (406)), and in turn, the base station (e.g., Base Station B (406)) communicates the data from the well (e.g., Well B (403) and Well logs B (442)) to a satellite (e.g., Satellite A (400)) using a surface antenna (e.g., Surface Antenna B (409)). Further considering the same possible pathway, the well (e.g., Well B (403)) further allows its base station (e.g., Base Station B (406)) access to adjusting its various parameters (e.g., Well production parameters B (439) and Logging parameters B (445)), and in turn, the base station (e.g., Base Station B (406)) enables the satellite (e.g., Satellite A (400)) access to adjusting the various parameters of the well (Well production parameters B (439) and Logging parameters B (445)) through its communication via the surface antenna (e.g., Surface Antenna B (409)). In summary, information is communicated from each well and base station to the satellite using the surface antennas, and information is communicated from the satellite to each base station and well using the surface antennas. Accordingly, the multi-well simultaneous logging system (e.g., Multi-well simultaneous logging system W (499)) is capable of gathering and storing data related to communication (i.e., transmitting and receiving) and remote measurement collectively as the transceiver data (412), data related to the overall activities of the plurality of wells as the well operation data (413), parameters that define the operation of elements related to communication and remote measurement as the set of transceiver parameters (415), and parameters that define the operation of the plurality of wells and their associated system as the set of well operation parameters (416). These data and parameters may be gathered and stored at a particular designated base station (e.g., Base Station B (406)) or onboard the satellite (e.g., Satellite A (400)). Alternatively, the data and parameters need not be gathered in stored in one physical location but may be distributed among the components of the multi-well simultaneous logging system (e.g., Multi-well simultaneous logging system W (499)) in such a way that the system as a whole has access to them.

Regarding data transfer, in some embodiments, the multi-well simultaneous logging system (e.g., Multi-well simultaneous logging system W (499)) uses a novel data compression method for compressing data prior to data transfer. Data compression refers to statistical and computational methods to represent digital information using fewer bits than the original data entity. Many techniques are known in the art to implement data compression, including adaptive coding, arithmetic compression, Shannon coding, byte pair encoding, and Lempel-Ziv algorithms, among others not listed. Data compression may be beneficial in endeavors sensitive to either static data volume (e.g., storing large numbers of files) or data throughput (e.g., transferring large numbers of files). In one or more embodiments, data that may be transferred (e.g., the transceiver data (412), the well operation data (415), etc.) is compressed using a novel method that integrates prediction by partial matching (PPM) as well as a decision tree ensemble model for the prediction step. Simply put, given a set of data, PPM involves building statistical models of portions of the uncompressed data to predict the portions of the uncompressed data that follow. Typically, a finite-context statistical model is used by PPM methods, wherein a probability distribution is constructed to represent the probability of a “next” data element, given the preceding data elements. In computer science, a decision tree is a non-parametric technique applicable to both classification and regression problems. Decision trees predict target outputs by learning “decision rules” from features of the data. One advantage to using a decision tree during the prediction step of PPM is that the computational resources required to make a prediction with a decision tree requires scale with the logarithm of the size of the data used to create the tree. When constructing decision trees, small variations in data, in some cases, lead to distinctly different “trees” being built. This well-known bias can be overcome by combining decision trees into ensembles, which, when taken together, make a single prediction. One popular example of this ensemble approach is the “random forest” algorithm, though embodiments of the instant disclosure are not limited to one specific ensemble method.

In accordance with one or more embodiments, the transceiver data (412), the well operation data (413), the set of transceiver parameters (415), and the set of well operation parameters (416) are processed by the dual AI model (e.g., Dual AI Model F (421)). In one or more embodiments, the result of the dual AI model (e.g., Dual AI model F (421)) is a prediction of the satellite performance (454) and a prediction of the well logging (457) given, at least, the transceiver data (412) and well operation data (413) in view of or along with the set of transceiver parameters (415) and the set of well operation parameters (416). The prediction of the satellite performance (454) may be quantified as the predicted time-averaged data transfer rate between the satellite and surface antennas, average aerial coverage of the base stations achieved by the satellite, or average communication latency between the satellite and surface antennas, among other metrics not listed. Meanwhile, the predicted well logging (457) may be represented in a variety of forms. In one or more embodiments, the predicted well logging (457) may include well logging measurements, such as resistivity, porosity, and radioactivity and their associated uncertainties for one or more wells.

While FIG. 4 depicts the dual AI model (e.g., Dual AI Model F (421)) as being applied to a multi-well simultaneous logging system (e.g., Multi-well simultaneous logging system W (499)) and the associated components, herein, the minimum number of satellites is one (e.g., Satellite A (400)), although some embodiments may include a plurality of satellites working together in concert. Regarding other elements of the multi-well simultaneous logging system, including base stations (e.g., Base Station B (406) and Base Station C (407)), surface antennas (e.g., Surface Antenna B (409) and Surface Antenna C (410)), and wells (e.g., Well B (403) and Well C (404)), the minimum number of each is two, though many more of each may be considered without limitation. As such, the dual AI model (e.g., Dual AI Model F (421)) may be applied across all considered base stations, surface antennas, and wells collectively, or across any of the possible, distinct combinations of listed facilities without limitation. Furthermore, when a plurality of satellites is considered, each individual satellite may communicate with each base station of the plurality of base stations, one base station alone, or any number of base stations without limitation.

In accordance with one or more embodiments, the transceiver data (412), the well operation data (413), the set of transceiver parameters (415), and the set of well operation parameters (416) may be pre-processed before being processed by the dual AI model (e.g., Dual AI Model F (421)). Pre-processing may include activities such as numericalization, filtering and/or smoothing of the data, scaling (e.g., normalization) of the data, feature selection, outlier removal (e.g., z-outlier filtering) and feature engineering. Feature selection includes identifying and selecting a subset of transceiver data or subset of well operation data with the greatest discriminative power with respect to predicting satellite performance (454) and/or predicting well logging (457). For example, in one embodiment, discriminative power may be quantified by calculating the strength of correlation between elements of the transceiver data (412) and the predicted quantities (e.g., predicted satellite performance (454)). Consequently, in some embodiments, not all of the transceiver data (412) need be passed to the dual AI model. Feature engineering encompasses combining, or processing, various transceiver data (412) to create derived quantities. The derived quantities can be processed by the dual AI model (e.g., Dual AI Model F (421)). For example, the transceiver data (412) may be processed by one or more “basis” functions such as a polynomial basis function or a radial basis function. In some embodiments, the transceiver data (412) is passed to the dual AI model (e.g., Dual AI Model F (421)) without pre-processing. Each of the previous steps describing pre-processing of data may equally be applied to the well operation data (413). Many additional pre-processing techniques exist such that one with ordinary skill in the art would not interpret those listed here as a limitation on the present disclosure.

In accordance with one or more embodiments, the predicted satellite performance (454) and the predicted well logging (457) are used to determine the set of transceiver parameters (415) and the set of well operation parameters (416) that optimizes satellite performance. In one or more embodiments, the predicted satellite performance (454) and the predicted well logging (457) are further used to determine the set of transceiver parameters (415) and the set of well operation parameters (416) that optimizes well logging. In one or more embodiments, the set of transceiver parameters (415) and the set of well operation parameters (416) define an operational state of a multi-well simultaneous logging system (e.g., Multi-well simultaneous logging system W (499)) and thus affect the multi-well simultaneous logging system in its ability to monitor and obtain accurate well logging measurements. Determining the optimal set of transceiver parameters and optimal set of well operation parameters is carried out by an optimizer (422) applied to the dual AI model (e.g., Dual AI Model F (421). Upon identifying the set of transceiver parameters and the set of well operation parameters that optimize satellite performance and/or well logging (i.e., the optimal set of transceiver parameters and the optimal set of well operation parameters), these sets of parameters may be applied across the multi-well simultaneous logging system (e.g., Multi-well simultaneous logging system W (499)) and associated components automatically using control systems that receive commands from a multi-control system (e.g., Multi-Control System I (410)). The multi-control system (e.g., Multi-Control System I (410)) may be located within a particular base station (e.g., Base Station B (406)) or onboard the satellite (e.g., Satellite A (400)). The command issued from the multi-control system (e.g., Multi-Control System I (410)), wherein the command is to apply the new sets of optimal parameters, is indicated by Command X (424). In one or more embodiments, Command X (424) is sent to the satellite (e.g., Satellite A (400)), and in response, the satellite (e.g., Satellite A (400)) transmits a second signal, Command Y (427), to the plurality of base stations (e.g., Base Station B (406) and Base Station C (407)). In this way, the multi-well simultaneous logging system (e.g., Multi-well simultaneous logging system W (499)) can efficiently update and monitor in real-time the operations across wells located arbitrarily far apart. In one or more embodiments, satellite performance and well logging is continuously monitored and recorded to ensure that the accepted optimal set of transceiver parameters and optimal set of well operation parameters maintain the multi-well simultaneous logging system at optimal logging and satellite performance. That is, the accepted set of transceiver parameters and the accepted set of well operation parameters are validated by measuring the satellite performance and the well logging and determining whether the satellite performance and well logging is improved after adjusting the set of transceiver parameters (415) to the optimal set of transceiver parameters and adjusting the set of well operation parameters (416) to the optimal set of well operation parameters.

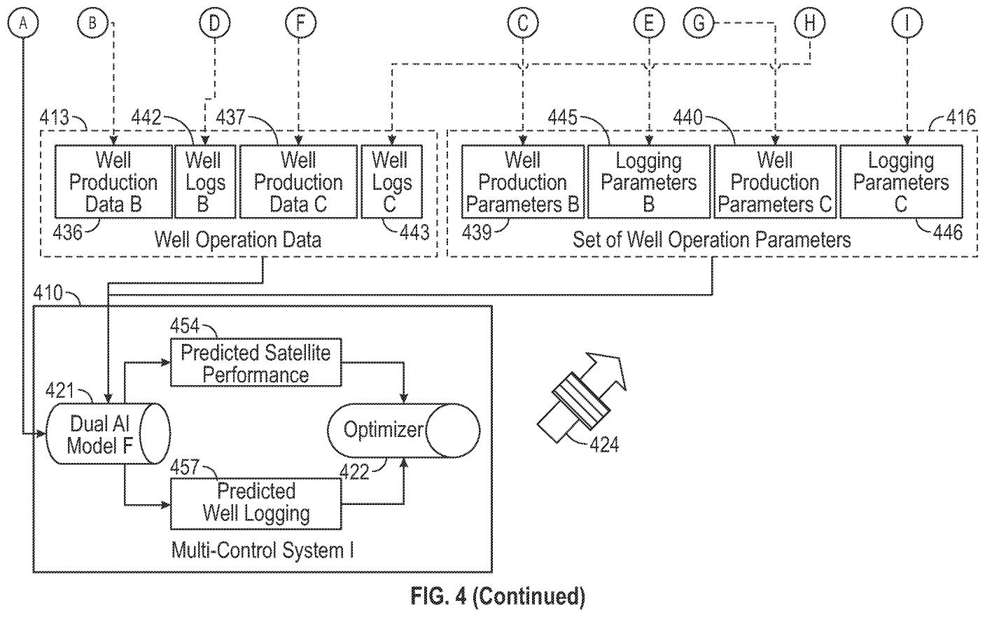

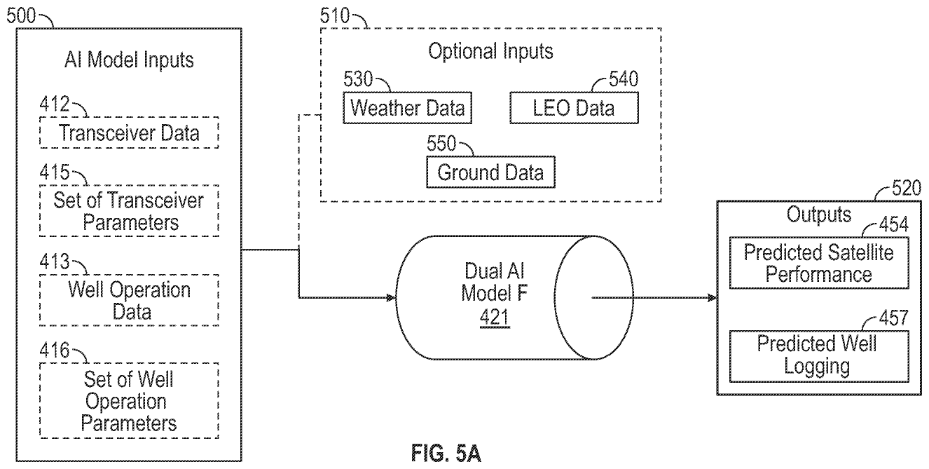

FIGS. 5A and 5B depict the use of the dual AI model (e.g., Dual AI Model F (421)) to predict outputs (520) including, at least, satellite performance (454) and well logging (457), the dual AI model (e.g., Dual AI Model F (421)) and predicted outputs (520) further used to determine the set of transceiver parameters and the set of well operation parameters that optimize the satellite performance and well logging, in accordance with one or more embodiments.

FIG. 5A depicts an embodiment using a dual AI model including at least one AI model (e.g., Dual AI Model F (421)). In one or more embodiments, the dual AI model (e.g., Dual AI Model F (421)) is trained using previously acquired, or historic, modelling data. The modelling data is composed of observed and measured (or otherwise estimated or simulated AI model “inputs” (500) and associated “outputs” (also known as “targets” in the context of training). The AI model inputs (500) include the set of transceiver parameters (415), which includes the satellite parameters and antenna parameters (not shown), the set of well operation parameters (416), which includes the well production parameters and logging parameters (not shown), the transceiver data, which includes the satellite data and link data (not shown), the well operation data, which includes the well production data and well logs (not shown), and all other data retained or derived quantities created after pre-processing (if applied). The transceiver data (412) and well operation data (413) may be collected over a period of time or may be acquired from analogous facilities. The outputs used for training the dual AI model, not to be confused with the outputs of the dual AI model itself (520), may include the actual measured satellite performance and the measured well logging at a given point in time or across some length of time. The AI model inputs listed are not to be considered limiting, and additional inputs may be considered in other embodiments without departing from the scope of this disclosure. For example, other optional inputs (510) may include low Earth orbit (LEO) data (540) as obtained from a publicly accessible database, the LEO data (540) including, for example, the trajectories and volume density of other objects in similar orbits as the satellites. The LEO data (540) in this case may provide physical constraints on the allowable orbits and positions of one or more satellites. Other optional inputs (510) may include weather data (530) obtained from public databases, the weather data (530) including cloud coverage or precipitation, which may impact the communication between satellites and surface antennas, and ground data (550), the ground data including other known characteristics about the geological environment of wells but obtained by systems not included in the multi-well simultaneous logging system that may affect well logging measurements.

In one or more embodiments, the AI model inputs (500) and other optional inputs (510) are used to train a dual AI model (e.g., Dual AI Model F (421)). The dual AI model (e.g., Dual AI Model F (421)) may be of any type known in the art. In some embodiments, multiple AI model types and/or architectures may be used to form the dual AI model (e.g., Dual AI Model F (421)). Generally, the AI model type and architecture with the greatest performance on a set of hold-out data is selected. Training an AI model involves processing data to develop a functional relationship between the inputs and the targets of the modelling data. The trained AI model may be described as a function relating the inputs (500) and the outputs (520). That is, the AI model may be mathematically represented as outputs=ƒ(inputs), such that given an input (500) the AI model (e.g., Dual AI Model F (421)) may produce an output (520). In one or more embodiments, the trained dual AI model, upon processing an input, produces two outputs, namely a predicted satellite performance (454) and a predicted well logging (457). In one or more embodiments, the dual AI model (e.g., Dual AI Model F (421)) may be a model that was previously trained on historic or analogous data, and no new data from the multi-well simultaneous logging system need be provided.

In some embodiments, the composite AI model (317) may include a plurality of AI models working in concert to predict satellite performance and well logging in a multi-well simultaneous logging system. FIG. 5B depicts an example where the dual AI model (e.g., Dual AI Model F (421)) includes a first AI model (593), a second AI model (595), in accordance with one or more embodiments. As shown, the first AI model (593) is used to predict satellite performance (454). Accordingly, the first AI model (593) accepts as inputs the data and parameters relevant to satellite performance, including the transceiver data (412) and the set of transceiver parameters (415), collectively referred to as first inputs (560). In some embodiments, the first AI model (593) may also accept as inputs other data relevant to the satellite performance (e.g., Optional First Inputs (570)), including weather data (530) and LEO data (540). Training targets for the first AI model (593) may include a history of data transfer rates between one or more satellites and the plurality of base stations. A second AI model (595) is used to predict well logging (457). Accordingly, the second AI model (595) accepts as inputs the data and parameters relevant to well logging, including the well operation data (413) and the set of well operation parameters (416), collectively referred to as second inputs (580). In some embodiments, the second AI model (595) may accept as inputs other data relevant to well logging (e.g., Optional Second Inputs (590)), including ground data (550), the ground data (550) including, for example, other known characteristics about the geological environment of wells but obtained by systems not included in the multi-well simultaneous logging system that may affect well logging measurements. In some embodiments, the transceiver data (412) includes measurements taken by the satellites related to the surroundings of the wells, such as spectroscopy, radiometry, or imaging indicating gas (i.e., carbon dioxide, methane, hydrogen, etc.) emission and/or content at the well, and data pertaining to temperature, all of which may be informative to well logging, and accordingly, the transceiver data (412) may be considered one of the optional second inputs (590) for the second AI model (595). Training targets for the second AI model may include past well logs from analogous wells in addition to the measured well logs from the logging systems. Whether the dual AI model (e.g., Dual AI Model F (421)) includes only one AI model, or a plurality of AI models working in concert, the output of the dual AI model (Outputs (411)) is the predicted satellite performance (454) and predicted well logging (457) of the multi-well simultaneous logging system. In one or more embodiments, either model (e.g., First AI Model (593) or Second AI Model (595)) of the dual AI model (e.g., Dual AI Model F (421)) may be a model that was previously trained on historic or analogous data, and no new data from the multi-well simultaneous logging system need be provided.

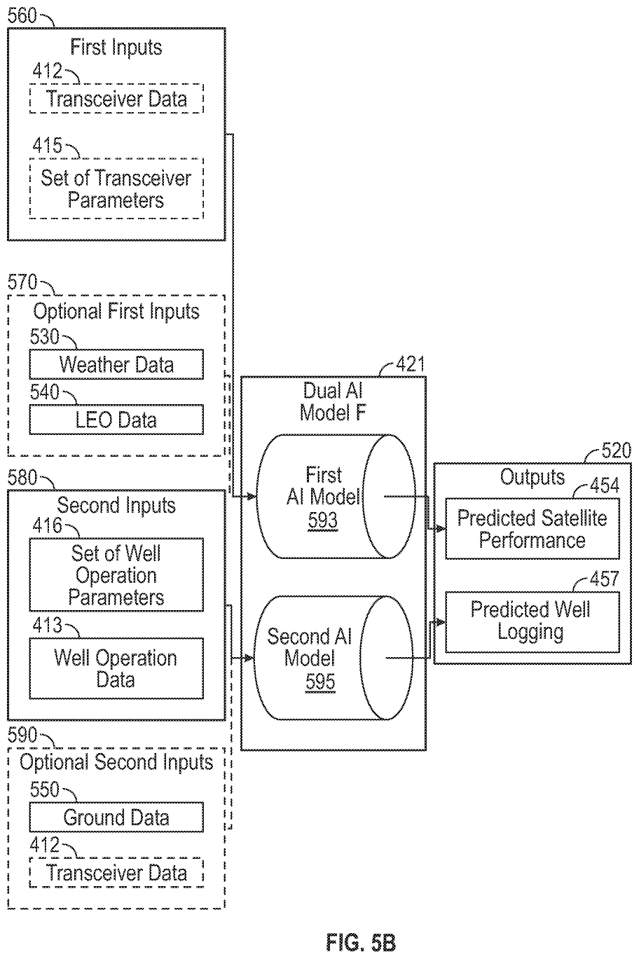

In accordance with one or more embodiments, an optimization algorithm or method is used to invert, or intelligently probe one or more inputs (e.g., the set of transceiver parameters (415), or the set of well operation parameters (416)) of the dual AI model (e.g., Dual AI Model F (421)) to determine the set of transceiver parameters and the set of well operation parameters that optimize satellite performance and well logging given the predicted satellite performance (454) and predicted well logging (457). A commonly used non-linear optimizer is the genetic algorithm (GA). An overview of the typical steps used in the genetic algorithm (GA) is provided in FIG. 6. The genetic algorithm (600) begins by generating an initial population or multiple populations (602). A population consists of one or more “individuals.” In the context of the genetic algorithm (600), an individual is a single representation, or encoding, of the function parameters over which optimization is to occur. In the case of the multi-well simultaneous logging system, the parameters over which optimization is to occur include states or values encompassed by the set of transceiver parameters and the set of well operation parameters. In this case, an individual is the assignment of values to each parameter while respecting any imposed constraints (e.g., not permitting the satellite trajectories and orbital adjustments that may cause collision with other spacecraft based on the LEO data (540)). The number of individuals in a population, and the method of initially generating individuals, are hyperparameters chosen by the user. When multiple populations are used, commonly referred to as an “island” scheme, the populations need not be initialized using the same set of hyperparameters.

Once a population(s) has been generated (602), the “fitness” of every individual in the population(s) is evaluated (604). For example, in the context of the dual AI model (e.g., Dual AI Model F (421)) described in FIGS. 5A, the parameter values of an individual are used to predict satellite performance (454) and well logging (457). Individuals are considered “more fit” when they achieve greater predicted satellite performance and/or more accurate well logging. For example, if the satellite performance is quantified by the average data transfer rate between one or more satellites and a plurality of surface antennas throughout one or more of a given satellite's orbit, individuals that achieve greater average data transfer rates are considered more fit. Similarly, individuals that achieve more accurate well logs, where “accurate” is taken to mean that the predicted well logging more closely matches the target well logging as computer by a so-called “loss function” (although other names for this comparison function such as “error function,” “misfit function,” and “cost function” are commonly employed), may be considered more fit.

Next, a stopping criterion is checked (606). Many stopping criteria exist, including, but not limited to, the number of iterations the genetic algorithm has run, the maximum or minimum fitness score achieved by an individual, the relative change in fitness scores between iterations, and the similarity of individuals in a population, or combinations of these criteria. If the algorithm is to stop, typically, the most fit individual(s) seen during the genetic algorithm process is selected (612) and the algorithm terminates. Likewise, if the genetic algorithm continues, one or more individuals from the population(s) are selected (608). This selection may be done by simply selecting the portion of the population with the highest fitness scores, or through a tournament process, or other selection mechanism.

Once individuals have been selected (608), the individuals may be propagated through without alteration, removed, or altered through so-called crossover, mutation, and differential evolution methods to create “offspring” (610). The offspring are themselves individuals; that is, new representations, or encodings, of the function parameters. It is noted that many evolutionary methods exist to create offspring and the preceding list is not all-inclusive and should be considered non-limiting. The offspring are then evaluated for fitness (604) and the process is repeated until the genetic algorithm stopping criterion is met.

Again, the description of the genetic algorithm (GA) provided in FIG. 6 is generalized and one skilled in the art will appreciate that many modifications can be made, and are regularly made, to the genetic algorithm (GA) without departing from its intended scope. For example, an enhanced genetic algorithm (eGA) is developed by including additional features such as: enforcing deliberately diverse initial populations; using heterogenous hyperparameters for each population; dynamically updating or scheduling changes to the selection process and offspring creation process; using a unidirectional migration policy between populations; adding additional checks, such as a premature convergence check; using a self-adaptive differential evolution method; performing a localized exhaustive search in regions of stagnation or saturation.

Other non-linear optimizers may be employed to optimize the predicted satellite performance (and/or the predicted well logging) and determine the optimal set of transceiver parameters and the optimal set of well operation parameters. The non-linear optimizer could be a Bayesian-based optimizer which elects new parameters based on an analysis of the updated posterior distribution. In this context, the level of exploration and exploitation would be determined by the user. In some embodiments, the optimal sets of parameters, as determined by the optimizer applied to the dual AI model, are validated by measuring the satellite performance and analyzing the well logging from the multi-well simultaneous logging system and determining whether the satellite performance and/or the well logging is improved after adjusting the set of transceiver parameters to the optimal set of transceiver parameters and the set of well operation parameters to the optimal set of well operation parameters.

In some embodiments, the optimizer may consider the predicted well logging (457) alongside the predicted satellite performance (454) during the optimization. That is, the optimizer may jointly optimize satellite performance while optimizing well logging. Accordingly, in one or more embodiments, the optimizer may seek the set of transceiver parameters and the set of well operation parameters that jointly achieves the combination of optimal satellite performance and optimal well logging. Mathematically, the optimization may take the form:

$${arg max}_{{S}_{1} , {S}_{2}} P + α W , \qquad ( 1 )$$

where the quantities P and W, representing the predicted satellite performance and the predicted well logging, respectively, are determined using the trained dual AI model (e.g., Dual AI Model F (421)), in accordance with one or more embodiments. Further, in EQ. 1, the set of transceiver parameters is denoted as S₁ and the set of well operation parameters is denoted as S₂. Thus, the optimizer jointly optimizes the predicted satellite performance and optimizes the predicted well logging over the set of transceiver parameters and the set of well operation parameters. EQ. 1 further makes uses of an optimization weighting factor (a). In EQ. 1, the optimization weighting factor is applied to the predicted well logging, however, this need not be the case. In some embodiments, the optimization weighting factor is applied to (as a product) the predicted satellite performance. The optimization weighting factor serves, at least, two purposes. First, the optimization weighting factor acts to scale either the predicted satellite performance or the predicted well logging (as shown in EQ. 1). Second, the optimization weighting factor weighs either the predicted satellite performance or the predicted well logging relative to the other output. In one or more embodiments, the optimization weighing factor is a predefined scalar such that the optimizer, when applied to a trained dual AI model processing transceiver data and well operation data, parameterized by the set of transceiver parameters and the set of well operation parameters, returns a single and optimal set of transceiver parameters and a single and optimal set of well operation parameters. In other embodiments, the optimization weighting factor is an array such that the optimizer returns an array of optimal sets of transceiver parameters and an array of optimal sets of well operation parameters. In this case, the optimization weighting factor array and associated sets of transceiver parameters and sets of well operation parameters define a so-called Pareto front. In such a case, an individual set of transceiver parameters and set of well operation parameters can be selected by a subject matter expert or automatically using a predefined criterion. One with ordinary skill in the art will appreciate that maximization and minimization may be made equivalent through simple techniques such as negation. As such, the choice to represent the optimization as a maximization as shown in EQ. 1 does not limit the scope of the present disclosure. Whether done through minimization or maximization, the optimizer identifies the set (or sets) of transceiver parameters and the set (or sets) or well operation parameters that jointly optimize satellite performance and well logging according to the trained dual AI model.

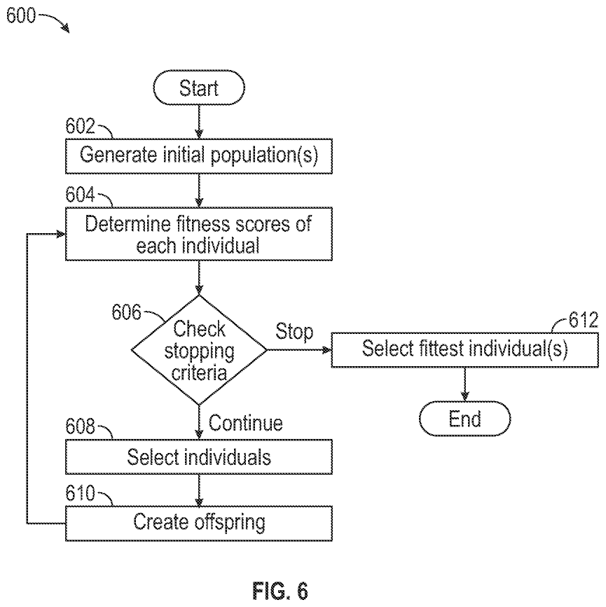

The process of evaluating transceiver data and determining the set of transceiver parameters that optimize satellite performance in a multi-well simultaneous logging system is summarized in the flow chart of FIG. 7. In Block 701, transceiver data for at least one satellite and a plurality of base stations is obtained, wherein each base station of the plurality of base stations includes at least one surface antenna. The transceiver data may include satellite data describing the status and/or measurements obtained by the satellite and link data from a plurality of transceiver of devices disposed throughout the base stations. The satellite may include a satellite control system which receives and issues commands to modify the state or behavior of one or more component of the satellite, including measurement devices onboard the satellite. Regarding the satellite data, the satellite data may include data about the position and orientation of one satellite (or several satellites, if more than one is used), and data from measurement devices included by one or more satellites such as imaging systems, radiometers, and spectrometers. The measuring devices of the one or more satellites may acquire temporal data, radiometric data, spatial data, and spectral data, each spanning radio through optical wavelengths. The transceiver devices disposed throughout the base stations may include various control systems as well as sensors which measure and quantify the link data according to the state of various components of the base station, in particular, the surface antennas. The measurements from the transceiver devices may include the current or history of orientations of one or more surface antennas and data transfer metrics between one or more satellites and one or more surface antennas. Additionally, the transceiver data may include other information provided by public databases regarding both weather and the locations/trajectories of other objects in orbit. In summary, the transceiver data may include measurements that affect the satellite performance, including measurements not listed.

In one or more embodiments, the transceiver data are pre-processed. Pre-processing may include numericalizing the data, scaling the data, selecting features from the data, and engineering features from the data.

In Block 703, transceiver parameters related to the at least one satellite and plurality of surface antennas are obtained. The transceiver parameters may include satellite parameters defining the operation of the one or more satellites and antenna parameters defining the operation of the plurality of surface antennas. The satellite parameters may include defining the real-time or future orientation and position (i.e., altering the orbit) of one or more satellites, defining the orientation of solar panels included by one or more satellites, and defining moments in time when one or more satellites employs an included measuring device. The antenna parameters may include defining the height, orientation and position of one or more surface antennas (if one or more of these features is adjustable), defining the amount of data to send to one or more satellites, and defining the moment in time to begin data transfer.

In Block 705, the transceiver data and the set of transceiver parameters are processed by a dual artificial intelligence (AI) model, including a first AI model, to predict satellite performance in a multi-well simultaneous logging system. Various embodiments of the dual AI model have been described with regards to FIGS. 5A and 5B. The dual AI model outputs a prediction of the satellite performance, according to the set of transceiver parameters and in view of the transceiver data. The satellite performance may be quantified in a number of ways. For example, the satellite performance may be quantified by the time-averaged data transfer rate between one or more satellites and one or more surface antennas, average aerial coverage of the base stations achieved by one or more satellites, or average communication latency between one or more satellites and one or more surface antennas, among other metrics not listed. In one or more embodiments, the dual AI model further outputs a prediction of the well logging as measured by logging systems included by the plurality of wells, the plurality of wells being associated with the plurality of base stations.

In Block 707, the optimal set of transceiver parameters are determined by an optimizer applied to the dual AI model such that satellite performance is optimized. In one or more embodiments, well logging, as determined using the dual AI model, is also considered when optimizing the satellite performance. One possible embodiment of the optimizer, the genetic algorithm (GA), has been described above and depicted in FIG. 6. Other optimizers may be employed, such as a Bayesian-based optimizer, without limitation.

In Block 709, the set of transceiver parameters are adjusted (e.g., through interactions between control systems in the at least one satellite and the plurality of base stations) to their optimal values as determined using the dual AI model and optimizer. This adjustment may be performed automatically and autonomously, or may be done manually, or may be checked by a “human-in-the-loop.”

Embodiments of the present disclosure may provide at least one of the following advantages. As noted, complex interactions between the components and sub-components of a multi-well simultaneous logging system, above-ground installations (e.g., base stations, wells, surface antennas, etc.), environmental and physical conditions (e.g., weather, or the positions and separations of the base stations) and space conditions (e.g., the positions and trajectories of other objects in orbit) exist and affect the processes of the multi-well simultaneous logging system. Configuring at least one satellite and a plurality of surface antennas for optimal satellite performance in a multi-well simultaneous logging system is a difficult and laborious task. Further, the state and behavior of multi-well simultaneous logging system may be transient according to the trajectories and orientations of one or more satellites, weather events which may impact remote communication, and the presence and trajectories of other objects in orbit, all of which may or may not vary depending on the operation of the satellites and other entities. By continuously receiving and processing transceiver data with a dual AI model, the multi-well simultaneous logging system can be maintained in an optimal state greatly reducing the cost and time required to identify optimal settings which change with the transient nature of the multi-well simultaneous logging system and the adjoining facilities. As previously noted, there are also many difficulties associated with well logging itself. However, by accounting for similar interference in sensing signals among different logging tools at different wells, the disclosed artificial intelligence methods enable combining measurements across wells to improve logging measurements. Ordinarily, gathering, combining, and processing data from wells in this way is challenging and complex, especially if the wells are substantially distant from one another and/or located in isolated locations. Communication of wells with a satellite via a surface antenna enables monitoring, controlling, and updating plans to well logging operations on vast scales and in remote locations. Furthermore, by continuously receiving and processing data from the wells with a dual AI model, the multi-well simultaneous logging system can maintain logging operations at an optimal state, greatly reducing the cost and time required to identify optimal settings for well logging.

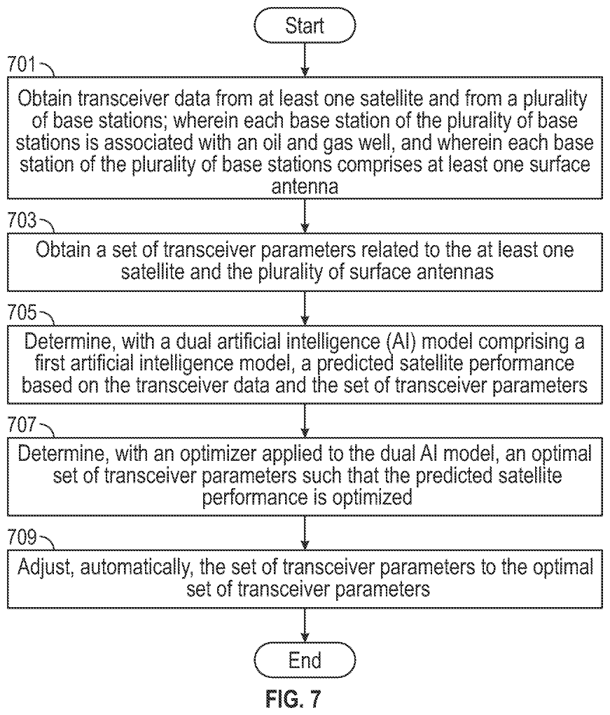

In accordance with one or more embodiments, one or more of the members of the dual AI model (e.g., Dual AI Model F (421)) discussed herein, such as the first AI model (593), may be a neural network. A diagram of a neural network is shown in FIG. 8. At a high level, a neural network (800) may be graphically depicted as being composed of nodes (802), where here any circle represents a node, and edges (804), shown here as directed lines. The nodes (802) may be grouped to form layers (805). FIG. 8 displays four layers (808, 810, 812, 814) of nodes (802) where the nodes (802) are grouped into columns, however, the grouping need not be as shown in FIG. 8. The edges (804) connect the nodes (802). Edges (804) may connect, or not connect, to any node(s) (802) regardless of which layer (805) the node(s) (802) is in. That is, the nodes (802) may be sparsely and residually connected. A neural network (800) will have at least two layers (805), where the first layer (808) is considered the “input layer” and the last layer (814) is the “output layer.” Any intermediate layer (810, 812) is usually described as a “hidden layer”. A neural network (800) may have zero or more hidden layers (810, 812) and a neural network (800) with at least one hidden layer (810, 812) may be described as a “deep” neural network or as a “deep learning method.” In general, a neural network (800) may have more than one node (802) in the output layer (814). In this case the neural network (800) may be referred to as a “multi-target” or “multi-output” network.

Nodes (802) and edges (804) carry additional associations. Namely, every edge is associated with a numerical value. The edge numerical values, or even the edges (804) themselves, are often referred to as “weights” or “parameters.” While training a neural network (800), numerical values are assigned to each edge (804). Additionally, every node (802) is associated with a numerical variable and an activation function. Activation functions are not limited to any functional class, but traditionally follow the form:

$$A = f ( {\sum }_{i ∈ ( incoming )} [ {( node value )}_{i} {( edge value )}_{i} ] ) , \qquad ( 3 )$$

where i is an index that spans the set of “incoming” nodes (802) and edges (804) and ƒ is a user-defined function. Incoming nodes (802) are those that, when viewed as a graph (as in FIG. 8), have directed arrows that point to the node (802) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node (802) in a neural network (800) may have a different associated activation function. Often, as a shorthand, activation functions are described by the function ƒ by which it is composed. That is, an activation function composed of a linear function ƒ may simply be referred to as a linear activation function without undue ambiguity.

When the neural network (800) receives an input, the input is propagated through the network according to the activation functions and incoming node (802) values and edge (804) values to compute a value for each node (802). That is, the numerical value for each node (802) may change for each received input. Occasionally, nodes (802) are assigned fixed numerical values, such as the value of 1, that are not affected by the input or altered according to edge (804) values and activation functions. Fixed nodes (802) are often referred to as “biases” or “bias nodes” (806), displayed in FIG. 8 with a dashed circle.

In some implementations, the neural network (800) may contain specialized layers (805), such as a normalization layer, or additional connection procedures, like concatenation. One skilled in the art will appreciate that these alterations do not exceed the scope of this disclosure.

As noted, the training procedure for the neural network (800) comprises assigning values to the edges (804). To begin training the edges (804) are assigned initial values. These values may be assigned randomly, assigned according to a prescribed distribution, assigned manually, or by some other assignment mechanism. Once edge (804) values have been initialized, the neural network (800) may act as a function, such that it may receive inputs and produce an output. As such, at least one input is propagated through the neural network (800) to produce an output. Recall, that a given data set will be composed of inputs and associated target(s), where the target(s) represent the “ground truth,” or the otherwise desired output. In accordance with one or more embodiments, the input of the neural network is the transceiver data (which may be pre-processed), the well operation data (which may be pre-processed), the set of transceiver parameters, and set of well operation parameters and the target is satellite performance (given as either quantities of data transfer over a pre-defined period or rates, in one or more embodiments).

The neural network (800) output is compared to the associated input data target(s). The comparison of the neural network (800) output to the target(s) is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (800) output and the associated target(s). The loss function may also be constructed to impose additional constraints on the values assumed by the edges (804), for example, by adding a penalty term, which may be physics-based, or a regularization term. Generally, the goal of a training procedure is to alter the edge (804) values to promote similarity between the neural network (800) output and associated target(s) over the data set. Thus, the loss function is used to guide changes made to the edge (804) values, typically through a process called “backpropagation.”

While a full review of the backpropagation process exceeds the scope of this disclosure, a brief summary is provided. Backpropagation consists of computing the gradient of the loss function over the edge (804) values. The gradient indicates the direction of change in the edge (804) values that results in the greatest change to the loss function. Because the gradient is local to the current edge (804) values, the edge (804) values are typically updated by a “step” in the direction indicated by the gradient. The step size is often referred to as the “learning rate” and need not remain fixed during the training process. Additionally, the step size and direction may be informed by previously seen edge (804) values or previously computed gradients. Such methods for determining the step direction are usually referred to as “momentum” based methods.

Once the edge (804) values have been updated, or altered from their initial values, through a backpropagation step, the neural network (800) will likely produce different outputs. Thus, the procedure of propagating at least one input through the neural network (800), comparing the neural network (800) output with the associated target(s) with a loss function, computing the gradient of the loss function with respect to the edge (804) values, and updating the edge (804) values with a step guided by the gradient, is repeated until a termination criterion is reached. Common termination criteria are: reaching a fixed number of edge (804) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (804) values are no longer intended to be altered, the neural network (800) is said to be “trained”.

In accordance with one or more embodiments, the dual AI model (e.g., Dual AI Model F (421)), or any AI model included in the dual AI model (e.g., Dual AI Model F (421)) (e.g., First AI Model (595)), used in the frameworks described herein may be a long short-term memory (LSTM) network. To best understand a LSTM network, it is helpful to describe the more general recurrent neural network, for which an LSTM may be considered a specific implementation.

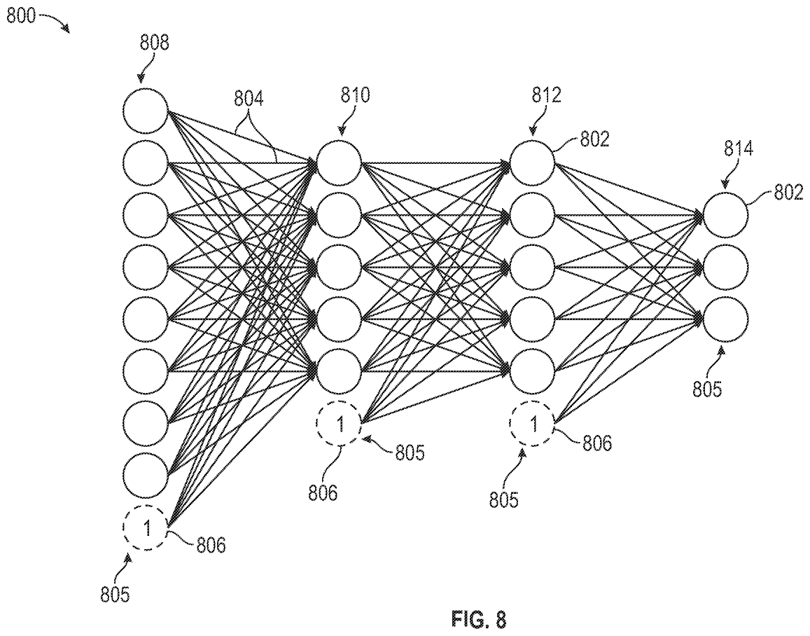

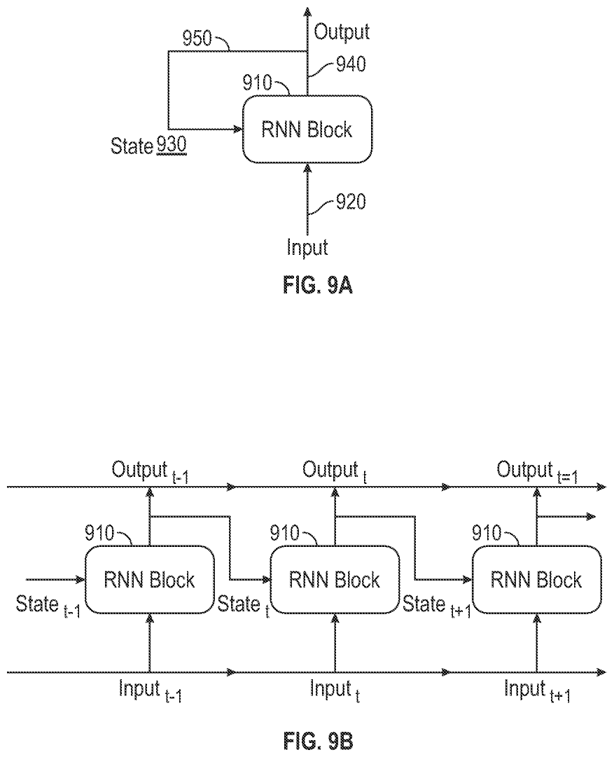

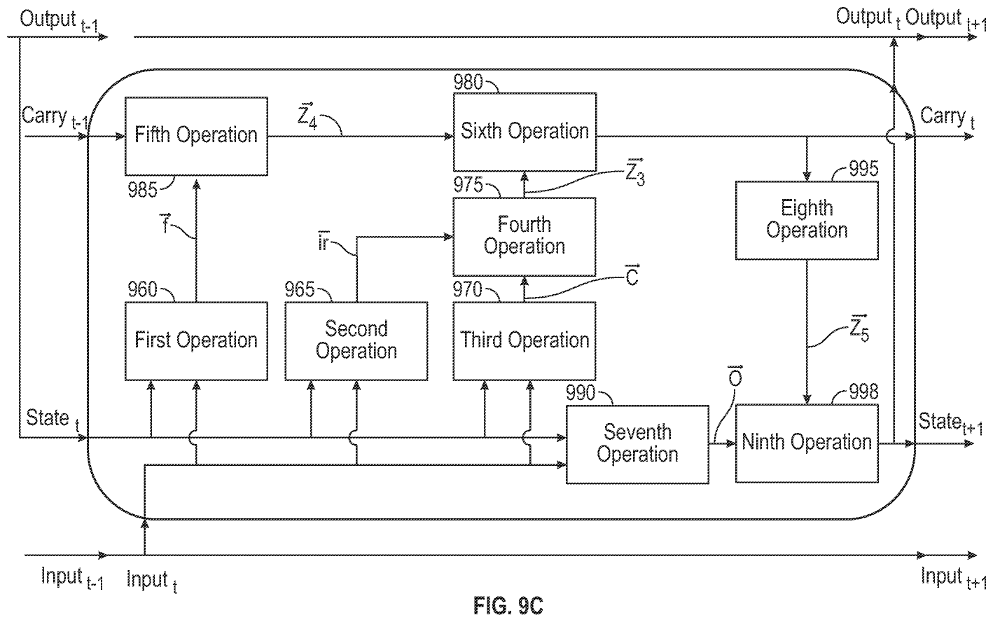

FIG. 9A depicts the general structure of a recurrent neural network (RNN). An RNN is graphically composed of an RNN Block (910) and a recurrent connection (950). The RNN Block may be thought of as a function which accepts an Input (920) and a State (930) and produces an Output (940). Without loss of generality, such a function may be written as

$$Ouput = RNN Block ( Input , State ) . \qquad ( 4 )$$

The RNN Block (910) generally comprises one or more matrices and one or more bias vectors. The elements of the matrices and bias vectors are commonly referred to as “weights” or “parameters” in the literature such that the matrices may be referenced as weight matrices or parameter matrices without ambiguity. It is noted that for situations with higher dimensional inputs (e.g., inputs with a tensor rank greater than or equal to 2), the weights of an RNN Block (910) may be contained in higher order tensors, rather than in matrices or vectors. For clarity, the present example will consider Inputs (920) as vectors or as scalars such that the RNN Block (910) comprises one or more weight matrices and bias vectors, however, one with ordinary skill in the art will appreciate that this choice does not impose a limitation on the present disclosure. Typically, an RNN Block (910) has two weight matrices and a single bias vector which are distinguished with an arbitrary naming nomenclature. A commonly employed naming convention is to call one weight matrix W and the other U and to reference the bias vector as b.

An important aspect of an RNN is that it is intended to process sequential, or ordered, data; for example, a time-series. In the RNN, the Input (920) may be considered a single part of a sequence. As an illustration, consider a sequence composed of Y parts. Each part may be considered an input, indexed by t, such that the sequence may be written as sequence=[input₁, input₂, inputₜ, . . . , input_{Y-1}, input_{Y}]. Each Input (920) (e.g., input₁ of a sequence) may be a scalar, vector, matrix, or higher-order tensor. Recall that a given seismic data set is composed of N_{c} traces (or channels) and Nₜ discrete time steps. In accordance with one or more embodiments, each Input (920) (or element of a sequence) is an array of traces at a single time step. That is, each Input (920) is considered a vector with N_{c} elements.

To process a sequence, an RNN receives the first ordered Input (920) of the sequence, input₁, along with a State (930), and processes them with the RNN Block (910) according to EQ. 4 to produce an Output (940). The Output (940) may be a scalar, vector, matrix, or tensor of any rank. For the present example, the Output (940) is considered a vector with k elements. The State (930) is of the same type and size as the Output (940) (e.g., a vector with k elements). For the first ordered input, the State (930) is usually initialized with all of its elements set to the value zero. For the second ordered Input (920), input₂, of the sequence, the Input (920) is processed similarly according to EQ. 4, however, the State (930) received by the RNN Block (910) is set to the value of the Output (940) determined when processing the first ordered Input (920). This process of assigning the State (930) the value of the last produced Output (940) is depicted with the recurrent connection (950) in FIG. 9A. All the Inputs (920) in a sequence are processed by the RNN Block (910) in this manner; that is, the State (930) associated with an Input (920) is the Output (940) of the RNN Block (910) produced by the previous Input (920) (with the exception of the first Input (920) in the sequence). In some implementations, each Output (940), one for each Input (910) within a sequence, is stored for later processing and use. In other implementations, only the final Output (940), or the Output (940) which is produced when the Input (920) input_{Y} is processed by the RNN Block (910), is retained.

In greater detail, the process of the RNN Block (910), or EQ. 4, may be generally written as:

$$Ouput = RNN Block ( input , state ) = f ( U \cdot state + W \cdot input + \vec{b} ) , \qquad ( 5 )$$

where W, U, and \vec{b} are the weight matrices and bias vector of the RNN Block (910), respectively, and ƒ is an “activation function.” Some functions for ƒ may include the and rectified

$$f ( x ) = \frac{1}{1 + {e}^{- x}} ,$$

linear unit (ReLU) function ƒ(x)=sigmoid function max (0, x), however, many additional functions are commonly employed.

To further illustrate a RNN, a pseudo-code implementation of a RNN is as follows.

RNN Algorithm

Note:
N_{c} = input length
k = output length
W ϵ [symbol] ^{kxk}
U ϵ [symbol] ^{kxk}^{_{c}}
\vec{b} ϵ [symbol] ^{k}
1: state = [0₁, 0₂, ..., 0ₖ₋₁, 0ₖ]^{T}
2: for input in sequence:
3: \vec{z}₁ = matmul(U, state)
4: \vec{z}₂ = matmul(W, input)
5: output = f (\vec{z}₁ + \vec{z}₂ + \vec{b})
6: state = output

In keeping with the previous examples, both the inputs and the outputs are considered vectors of lengths N_{c} and k, respectively, however, in general, this need not be the case. With the lengths of these vectors defined, the shapes of the weight matrices, bias vector, and State (930) vector may be specified. To begin processing a sequence, the State (930) vector is initialized with values of zero as shown in line 1 of the pseudo-code. Note that in some implementations, the number of inputs contained within a sequence may not be known or may vary between sequences. One with ordinary skill in the art will recognize that an RNN may be implemented without knowing, beforehand, the length of the sequence to be processed. This is demonstrated in line 2 of the pseudo-code by indicating that each input in the sequence will be processed sequentially without specifying the number of inputs in the sequence. Once an Input (920) is received, a matrix multiplication operator is applied between the weight matrix U and the State (930) vector. The resulting product is assigned to the temporary variable \vec{z}₁. Likewise, a matrix multiplication operator is applied between the weight matrix W and the Input (910) with the result assigned to the variable \vec{z}₂. For the present example, due the Input (920) and Output (940) each being defined as vectors, the products in lines 3 and 4 of the pseudo-code may be expressed as matrix multiplications, however, in general, the dot product between the weight matrix and corresponding State (930) or Input (920) may be applied. The Output (940) is determined by summing \vec{z}₁, \vec{z}₂, and the bias vector b and applying the activation function ƒ elementwise. The State (930) is set to the Output (940) and the whole process is repeated until each Input (920) in a sequence has been processed.

FIG. 9B depicts an “unrolled” version of the RNN of FIG. 9A. Unrolling the RNN allows one to see how the sequential inputs, indexed by t, produce sequential outputs and how the state is passed through various inputs of the sequence. It is noted that while the “unrolled” depiction shows multiple RNN Blocks (910), these blocks are the same such that they are comprised of the same weight matrices and bias vector.

As previously stated, generally, training a machine-learned model requires that pairs of inputs and one or more targets (i.e., a training dataset) are passed to the machine-learned model. During this process the machine-learned model “learns” a representative model which maps the received inputs to the associated outputs. In the context of an RNN, the RNN receives a sequence, wherein the sequence can be partitioned into one or more sequential parts (Inputs (920) above), and maps the sequence to an overall output, which may also be a sequence. To remove ambiguity and distinguish the overall output of an RNN from any intermediate Outputs (940) produced by the RNN Block (910), the overall output will be referred to herein as a RNN result. In other words, an RNN receives a sequence and returns a RNN result. The training procedure for a RNN comprises assigning values to the weight matrices and bias vector of the RNN Block (910). For brevity, the elements of the weight matrices and bias vector will be collectively referred to as the RNN weights. To begin training the RNN weights are assigned initial values. These values may be assigned randomly, assigned according to a prescribed distribution, assigned manually, or by some other assignment mechanism. Once the RNN weights have been initialized, the RNN may act as a function, such that it may receive a sequence and produce a RNN result. As such, at least one sequence may be propagated through the RNN to produce a RNN result. For training, a training dataset is composed of one or more sequences and desired RNN results, where the desired RNN results represent the “ground truth”, or the true RNN results that should be returned for the given sequences. For clarity, and consistency with previous discussions of machine-learned model training, the desired or true RNN results will be referred to as targets. When processing sequences, the RNN result produced by the RNN is compared to the associated target. The comparison of a RNN result to the target(s) is typically performed by a loss function. As before, other names for this comparison function such as “error function” and “cost function” are commonly employed. Many types of loss functions are available, such as the mean squared error function, however, the general characteristic of a loss function is that the loss function provides a numerical evaluation of the similarity between the RNN result and the associated target(s). The loss function may also be constructed to impose additional constraints on the values assumed by RNN weights, for example, by adding a penalty term, which may be physics-based, or a regularization term. Generally, the goal of a training procedure is to alter the RNN weights to promote similarity between the RNN results and associated targets over the training dataset. Thus, the loss function is used to guide changes made to the RNN weights, typically through a process called “backpropagation through time.”

A long short-term memory (LSTM) network may be considered a specific, and more complex, instance of a recurrent neural network (RNN). FIG. 9C is an unrolled depiction of a LSTM where the internal components of the LSTM are displayed as labelled abstractions. A LSTM, like a RNN, has a recurrent connection, such that the output produced by a single input in a sequence is forwarded as the state to be used with the subsequent input. However, an LSTM also possesses another “state-like” data structure commonly referred to as the “carry.” The carry, like the state and input may be a scalar, vector, matrix, or tensor of any rank depending on the context of the application. Like unto the description of the RNN, for simplicity, the carry will be considered a vector in the following discussion of the LSTM. The LSTM receives an input, state, and carry and produces an output and a new carry. The output and the new carry are passed to the LSTM as the state and carry for the subsequent input. This sequential process, indexed by t, may be described functionally as:

$$( {output}_{t} , {carry}_{t} ) = LSTM Block ( {input}_{t} , {carry}_{t - 1} , {state}_{t} ) = LSTM Block ( {input}_{t} , {carry}_{t - 1} , {output}_{t - 1} ) , \qquad ( 6 )$$

where the LSTM Block, like the RNN Block, comprises one or more weight matrices and bias vectors and the processing steps necessary to transform an input, state, and carry to an output and new carry.

LSTMs may be configured in a variety of ways, however, the processes depicted in FIG. 9C are the most common. As shown in FIG. 9C, an LSTM Block receives an input (input ₜ), a state (state ₜ), and a carry (carry ₜ₋₁). Again, assuming that the inputs, carry, and outputs are all vectors, the weights of the LSTM Block may be considered to reside in eight matrices and four bias vectors. These matrices and vectors are conventionally named Wᵢ, Uᵢ, W_{ƒ}, U_{ƒ}, W_{c}, U_{c}, Wₒ, Uₒ and \vec{b}ᵢ, \vec{b}_{ƒ}, \vec{b}_{c}, \vec{b}ₒ, respectively. The processes of the LSTM Block are as follows. Block 960 represents the following first operation:

$$\vec{f} = {a}_{1} ( {U}_{f} \cdot {state}_{t} + {W}_{f} \cdot {input}_{t} + {\vec{b}}_{f} ) , \qquad ( 7 )$$

where α₁ is an activation function applied elementwise to the result of the parenthetical expression and the resulting vector is \vec{ƒ}. Block 965 implements the following second operation:

$$\vec{ι} = {a}_{2} ( {U}_{i} \cdot {state}_{t} + {W}_{i} \cdot {input}_{t} + {\vec{b}}_{i} ) , \qquad ( 8 )$$

Where α₂ is an activation function which may be the same or different to α₁ and is applied elementwise to the result of the parenthetical expression. The resulting vector is \vec{i}. Block 970 implements the following third operation:

$$\vec{c} = {a}_{3} ( {U}_{c} \cdot {state}_{t} + {W}_{c} \cdot {input}_{t} + {\vec{b}}_{c} ) , \qquad ( 9 )$$

where α₃ is an activation function which may be the same or different to either α₁ or α₂ and is applied elementwise to the result of the parenthetical expression. The resulting vector is \vec{c}. In block 975, vectors \vec{i} and \vec{c} are multiplied according to a fourth operation:

$${\vec{z}}_{3} = \vec{l} ⊙ \vec{c} , \qquad ( 10 )$$

where ⊙ indicates the Hadamard product (i.e., elementwise multiplication). Likewise, in block 985 the carry vector from the previous sequential input (carry ₜ₋₁) vector and the vector \vec{ƒ} are multiplied according to a fifth operation:

$${\vec{z}}_{4} = {carry}_{t - 1} ⊙ \vec{f} . \qquad ( 11 )$$

The results of the operations of blocks 975 and 985 (\vec{z}₃ and \vec{z}₄, respectively) are added together in block 980, a sixth operation, to form the new carry (carry ₜ):

$${carry}_{t} = {\vec{z}}_{3} + {\vec{z}}_{4} . \qquad ( 12 )$$

In block 990, the current input and state vectors are processed according to a seventh operation:

$$\vec{o} = {a}_{4} ( {U}_{o} \cdot {state}_{t} + {W}_{o} \cdot {input}_{t} + {\vec{b}}_{o} ) , \qquad ( 13 )$$

Where α₄ is an activation function which may be unique or identical to any other used activation function and is applied elementwise to the result of the parenthetical expression. The result is the vector \vec{o}. In block 995, an eighth operation, the new carry (carry ₜ) is passed through an activation function α₅. The activation as is usually the hyperbolic tangent function but may be any known activation function. The eighth operations (block 995) may be represented as:

$${\vec{z}}_{5} = {a}_{5} ( {carry}_{t} ) . \qquad ( 14 )$$

Finally, the output of the LSTM Block (output t) is determined in block 998 by taking the Hadamard product of \vec{z}₅ and \vec{o}, a ninth operation shown mathematically as:

$${output}_{t} = {\vec{z}}_{5} ⊙ \vec{o} . \qquad ( 15 )$$

The output of the LSTM Block is used as the state vector for the subsequent input. Again, as in the case of the RNN, the outputs of the LSTM Block applied to a sequence of inputs may be stored and further processed or, in some implementations, only the final output is retained. While the processes of the LSTM Block described above used vector inputs and outputs, it is emphasized that an LSTM network may be applied to sequences of any dimensionality. In these circumstances the rank and size of the weight tensors will change accordingly. One with ordinary skill in the art will recognize that there are many alterations and variations that can be made to the general LSTM structure described herein, such that the description provided does not impose a limitation on the present disclosure.

While multiple embodiments using different AI models have been suggested, one skilled in the art will appreciate that this process, of determining the set of transceiver parameters and set of well operation parameters that optimize satellite performance (and in some embodiments, well logging), is not limited to the listed AI models. AI models such as a random forest, support vector machines, or non-parametric methods such as K-nearest neighbors may be readily inserted into this framework and do not depart from the scope of this disclosure.

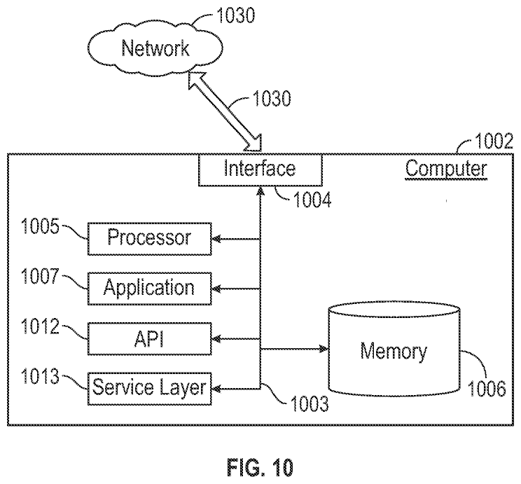

Embodiments may be implemented on a computer system. FIG. 10 is a block diagram of a computer system (1002) used to provide computational functionalities associated with described algorithms, methods, functions, processes, flows, and procedures as described in the instant disclosure, according to one or more embodiments. The illustrated computer (1002) is intended to encompass any computing device such as a server, desktop computer, laptop/notebook computer, wireless data port, smart phone, personal data assistant (PDA), tablet computing device, one or more processors within these devices, or any other suitable processing device such as an edge computing device, including both physical or virtual instances (or both) of the computing device. An edge computing device is a dedicated computing device that is, typically, physically adjacent to the process or control with which it interacts. For example, the AI model may be implemented on an edge computing device in order to quickly provide optimal sets of transceiver parameters and well operation parameters to associated devices or their controllers.

Additionally, the computer (1002) may include a computer that includes an input device, such as a keypad, keyboard, touch screen, or other device that can accept user information, and an output device that conveys information associated with the operation of the computer (1002), including digital data, visual, or audio information (or a combination of information), or a GUI.

The computer (1002) can serve in a role as a client, network component, a server, a database or other persistency, or any other component (or a combination of roles) of a computer system for performing the subject matter described in the instant disclosure. In some implementations, one or more components of the computer (1002) may be configured to operate within environments, including cloud-computing-based, local, global, or other environment (or a combination of environments).

At a high level, the computer (1002) is an electronic computing device operable to receive, transmit, process, store, or manage data and information associated with the described subject matter. According to some implementations, the computer (1002) may also include or be communicably coupled with an application server, e-mail server, web server, caching server, streaming data server, business intelligence (BI) server, or other server (or a combination of servers).

The computer (1002) can receive requests over network (1030) from a client application (for example, executing on another computer (1002) and responding to the received requests by processing the said requests in an appropriate software application. In addition, requests may also be sent to the computer (1002) from internal users (for example, from a command console or by other appropriate access method), external or third-parties, other automated applications, as well as any other appropriate entities, individuals, systems, or computers.

Each of the components of the computer (1002) can communicate using a system bus (1003). In some implementations, any or all of the components of the computer (1002), both hardware or software (or a combination of hardware and software), may interface with each other or the interface (1004) (or a combination of both) over the system bus (1003) using an application programming interface (API) (1012) or a service layer (1013) (or a combination of the API (1012) and service layer (1013). The API (1012) may include specifications for routines, data structures, and object classes. The API (1012) may be either computer-language independent or dependent and refer to a complete interface, a single function, or even a set of APIs. The service layer (1013) provides software services to the computer (1002) or other components (whether or not illustrated) that are communicably coupled to the computer (1002). The functionality of the computer (1002) may be accessible for all service consumers using this service layer. Software services, such as those provided by the service layer (1013), provide reusable, defined business functionalities through a defined interface. For example, the interface may be software written in JAVA, C++, or other suitable language providing data in extensible markup language (XML) format or another suitable format. While illustrated as an integrated component of the computer (1002), alternative implementations may illustrate the API (1012) or the service layer (1013) as stand-alone components in relation to other components of the computer (1002) or other components (whether or not illustrated) that are communicably coupled to the computer (1002). Moreover, any or all parts of the API (1012) or the service layer (1013) may be implemented as child or sub-modules of another software module, enterprise application, or hardware module without departing from the scope of this disclosure.

The computer (1002) includes an interface (1004). Although illustrated as a single interface (1004) in FIG. 10, two or more interfaces (1004) may be used according to particular needs, desires, or particular implementations of the computer (1002). The interface (1004) is used by the computer (1002) for communicating with other systems in a distributed environment that are connected to the network (1030). Generally, the interface (1004) includes logic encoded in software or hardware (or a combination of software and hardware) and operable to communicate with the network (1030). More specifically, the interface (1004) may include software supporting one or more communication protocols associated with communications such that the network (1030) or interface's hardware is operable to communicate physical signals within and outside of the illustrated computer (1002).

The computer (1002) includes at least one computer processor (1005). Although illustrated as a single computer processor (1005) in FIG. 10, two or more processors may be used according to particular needs, desires, or particular implementations of the computer (1002). Generally, the computer processor (1005) executes instructions and manipulates data to perform the operations of the computer (1002) and any algorithms, methods, functions, processes, flows, and procedures as described in the instant disclosure.

The computer (1002) also includes a memory (1006) that holds data for the computer (1002) or other components (or a combination of both) that can be connected to the network (1030). The memory may be a non-transitory computer readable medium. For example, memory (1006) can be a database storing data consistent with this disclosure. Although illustrated as a single memory (1006) in FIG. 10, two or more memories may be used according to particular needs, desires, or particular implementations of the computer (1002) and the described functionality. While memory (1006) is illustrated as an integral component of the computer (1002), in alternative implementations, memory (1006) can be external to the computer (1002).

The application (1007) is an algorithmic software engine providing functionality according to particular needs, desires, or particular implementations of the computer (1002), particularly with respect to functionality described in this disclosure. For example, application (1007) can serve as one or more components, modules, applications, etc. Further, although illustrated as a single application (1007), the application (1007) may be implemented as multiple applications (1007) on the computer (1002). In addition, although illustrated as integral to the computer (1002), in alternative implementations, the application (1007) can be external to the computer (1002).

There may be any number of computers (1002) associated with, or external to, a computer system containing computer (1002), wherein each computer (1002) communicates over network (1030). Further, the term “client,” “user,” and other appropriate terminology may be used interchangeably as appropriate without departing from the scope of this disclosure. Moreover, this disclosure contemplates that many users may use one computer (1002), or that one user may use multiple computers (1002).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining transceiver data from at least one satellite and from a plurality of base stations;
wherein each base station of the plurality of base stations is associated with an oil and gas well, and wherein each base station of the plurality of base stations comprises at least one surface antenna;
obtaining a set of transceiver parameters related to the at least one satellite and the plurality of surface antennas;
determining, with a dual artificial intelligence (AI) model comprising a first artificial intelligence model, a predicted satellite performance based on the transceiver data and the set of transceiver parameters;
determining, with an optimizer applied to the dual AI model, an optimal set of transceiver parameters such that the predicted satellite performance is optimized; and
adjusting, automatically, the set of transceiver parameters to the optimal set of transceiver parameters.

2. The method of claim 1, further comprising:
obtaining well operation data from the plurality of oil and gas wells associated with one or more subsurface formations;
obtaining a set of well operation parameters related to the operation of the plurality of wells;
wherein obtaining the well operation data and the set of well operation parameters comprises communicating with the at least one satellite using one or more of the plurality of surface antennas comprised by the plurality of base stations;
determining, with the dual AI model, a predicted well logging from the plurality of wells based on, at least, the well operation data and well operation parameters,
determining, with the optimizer applied to the dual AI model, the optimal set of well operation parameters such that the predicted well logging is optimized across the plurality of wells; and
adjusting, automatically, the set of well operation parameters to the optimal set of well operation parameters.

3. The method of claim 1:
wherein the transceiver data comprises:
link data related to communication between the at least one satellite and the plurality of surface antennas comprised by the plurality of base stations, and
satellite data related to measurements acquired by the at least one satellite;
wherein the set of transceiver parameters comprise:
satellite parameters, and
antenna parameters.

4. The method of claim 2:
wherein the well operation data comprises:
well production data from a well control system, and
well logs from a logging system;
wherein the set of well operation parameters comprise:
well production parameters, and
logging parameters.

5. The method of claim 2, further comprising obtaining transceiver data from the at least one satellite and the plurality of base stations, wherein the dual AI model is informed by the transceiver data.

6. The method of claim 1 further comprising:
measuring the satellite performance; and
validating the optimal set of transceiver parameters by determining whether the satellite performance is improved after adjusting the set of transceiver parameters to the optimal set of transceiver parameters.

7. The method of claim 1, wherein optimizing the predicted satellite performance comprises maximizing an average data transfer rate between the at least one satellite and the plurality of surface antennas.

8. The method of claim 3, wherein the satellite parameters comprise defining a real-time or future orientation of the at least one satellite.

9. The method of claim 4, wherein the logging parameters comprise defining an amplitude, a frequency, or a phase shift of an electrical sensing signal that is produced by a well logging resistivity tool.

10. The method of claim 1, further comprising obtaining weather data from one or more weather stations in proximity to one or more of the plurality of surface antennas, wherein the dual AI model is informed by the weather data.

11. The method of claim 1, wherein the dual AI model further comprises:
a second AI model that determines the predicted well logging based on, at least, the well operation data and set of well operation parameters;
wherein the first AI model determines the predicted satellite performance based on, at least, the transceiver data and set of transceiver parameters.

12. The method of claim 10, wherein the first AI model is a long short-term memory network.

13. A system, comprising:
a plurality of base stations;
a satellite in communication with the plurality of base stations;
wherein the satellite comprises a satellite control system configured to adjust satellite parameters related to the satellite;
wherein each base station of the plurality of base stations is associated with an oil and gas well, and wherein each base station of the plurality of base stations comprises at least one surface antenna,
wherein the operation of the satellite and the plurality of surface antennas comprised by the plurality of base stations is defined by a set of transceiver parameters;
a plurality of transceiver devices disposed throughout the plurality of base stations, the plurality of transceiver devices gathering transceiver data from the satellite and the plurality of surface antennas;
a control system configured to adjust one or more transceiver devices in the plurality of base stations; and
a computer configured to:
obtain the transceiver data for the satellite and the plurality of surface antennas,
obtain the set of transceiver parameters for the satellite and the plurality of surface antennas,
determine, with a dual AI model comprising a first AI model, a predicted satellite performance based on the transceiver data and the set of transceiver parameters,
determine, with an optimizer applied to the dual AI model, an optimal set of transceiver parameters such that the predicted satellite performance is optimized, and
adjust, automatically, the set of transceiver parameters to the optimal set of transceiver parameters to optimize the predicted satellite performance.

14. The system of claim 13:
wherein the transceiver data comprises:
link data related to communication between the satellite and the plurality of surface antennas comprised by the plurality of base stations, and
satellite data related to measurements acquired by the satellite;
wherein the set of transceiver parameters comprise:
satellite parameters, and
antenna parameters.

15. The system of claim 13, further comprising:
a plurality of field devices and logging tools disposed throughout the plurality of wells associated with the plurality of base stations, the field devices and logging tools gathering well operation data from the plurality of wells;
wherein each well of the plurality of wells is comprises a well control system configured to adjust one or more of the field devices in the plurality of wells;
wherein each well of the plurality of wells comprises a logging system configured to adjust one or more of the logging tools in the plurality of wells;
wherein the operation of the well control system and logging system is defined by a set of well operation parameters; and
a computer configured to:
obtain the well operation data for the plurality of wells,
obtain the set of well operation parameters for the well control system and logging system,
wherein obtaining the well operation data and the set of well operation parameters comprises communicating with the satellite using one or more of the plurality of surface antennas comprised by with the plurality of base stations,
determine, with the dual AI model, a predicted well logging based on, at least, the well operation data and the set of well operation parameters,
determine, with an optimizer applied to the dual AI model, an optimal set of well operation parameters such that the predicted well logging is optimized across the plurality of wells, and
adjust, automatically, the set of well operation parameters to the optimal set of well operation parameters to optimize the predicted well logging across the plurality of wells.

16. The system of claim 15:
wherein the well operation data comprises:
well production data, and
well logs;
wherein the set of well operation parameters comprise:
well production parameters, and
logging parameters.

17. The system of claim 13, wherein the satellite is shielded from harmful radiation during orbit, atmospheric friction upon reentry, and water impact when reaching the Earth's surface.

18. The system of claim 13, wherein the computer is further configured to:
measure the satellite performance; and
validate the optimal set of transceiver parameters by determining whether the satellite performance is improved after adjusting the set of transceiver parameters to the optimal set of transceiver parameters.

19. The system of claim 13, wherein the dual AI model further comprises:
a second AI model that determines the predicted well logging based on, at least, the well operation data and set of well operation parameters;
wherein the first AI model determines the predicted satellite performance based on, at least, the transceiver data and set of transceiver parameters.

20. A non-transitory computer-readable memory comprising computer-executable instructions stored thereon that, when executed on a processor, cause the processor to perform steps comprising:
obtaining transceiver data for at least one satellite and a plurality of surface antennas, the plurality of surfaces antennas being comprised by a plurality of base stations associated with oil and gas wells;
determining, with a dual artificial intelligence (AI) model comprising a first AI model, a predicted satellite performance based on the transceiver data, in view of a set of transceiver parameters that control the operation of the at least one satellite and plurality of surface antennas;
determining, with an optimizer applied to the dual AI model, an optimal set of transceiver parameters such that the predicted satellite performance is optimized; and
adjusting, automatically, the set of transceiver parameters to the optimal set of transceiver parameters.
